(19) United States
(12) Patent Application Publication
(10) Pub. No.: US 2005/0114141 A1
(43) Pub. Date: May 26, 2005

(54) Methods and apparatus for providing services using speech recognition

(76) Inventor: Stephen D. Grody, Newton, MA (US)

Correspondence Address: GOODWIN PROCTER LLP;PATENT ADMINISTRATOR, 53 STATE PLACE, EXCHANGE PLACE, BOSTON, MA, 02109-2881, US

(21) Appl. No.: 10/934,071

(22) Filed: Sep. 3, 2004

Related U.S. Application Data
(60) Provisional application No. 60/550,655, filed on Mar. 5, 2004.
(60) Provisional application No. 60/500,533, filed on Sep. 5, 2003.

(51) Int. Cl. G10L 21/00

(52) U.S. Cl. 704/270

(57) ABSTRACT

Methods and apparatus for the recognition and processing of spoken requests. Spoken sounds are received, identified, and processed for requests that are serviceable. If processing fails to identify requests, or yields commands that are not entirely serviceable by the apparatus in the customer's premises, the spoken sounds, in either a fully processed, partially processed, or unprocessed state, are transmitted to for further processing. Commands first identified or simply routed for execution are processed and made effective using remote apparatus and/or using the apparatus in the customer's premises.

### CROSS-REFERENCE TO RELATED APPLICATIONS

The present application claims the benefit of co-pending provisional application No. 60/550,655, filed on Mar. 5, 2004, and co-pending provisional application No. 60/500,553, filed on Sep. 5, 2003, the entire disclosures of which are incorporated by reference as if set forth in their entirety herein.

### FIELD OF THE INVENTION

The present invention relates generally to speech recognition, and more specifically to the use of speech recognition for content selection and the provision of services to a user.

### BACKGROUND OF THE INVENTION

Cable television and competing systems (e.g., DIRECTV) collect television content from many sources, organize the content into a channel line-up, and transmit the line-up to their customers' television sets for viewing. As analog cable systems first became increasingly popular, traditional paper schedules of broadcast television content, e.g., TV GUIDE, were expanded to include listings for cable content and then adapted for transmission over cable systems in the form of an electronic program guide. To use these electronic program guides, viewers tuned their set top box or cable-ready television to the channel displaying the electronic program guide, reviewed the electronic program guide for a program of interest, identified the corresponding channel number, and then re-tuned their set top box or cable-ready television to the identified cable channel.

In the 1990s, cable system operators began to replace their analog cable systems with digital cable systems and, accordingly, to replace the analog method for delivering and displaying the electronic program guide. Now, on a digital cable system, data describing the television content on available channels is periodically transmitted from a carousel server to a digital set top box. In a typical configuration, such as the configuration illustrated in FIG. 1, a digital set top box 100 uses the locally-stored data from the carousel server to display the electronic program guide on a consumer electronic device 104 (such as a television) and changes the displayed guide images in response to commands issued by a viewer using a remote control unit 108.

Digital cable systems, direct broadcast satellite systems, fiber optic loops, and broadband wireless systems, such as MMDS, give delivery system operators (DSOs) greater capacity to deliver channels to viewers. As DSOs increase the number of channels they provide to their customers, the accompanying program guides can grow to potentially unwieldy sizes to display the increasingly larger numbers of available channels. Using a keypad-based remote control unit to interact with a program guide having hundreds of available channels is inconvenient and, therefore, a need exists for methods and apparatus that allow for the simplified selection of desired television programming.

Further complicating the consumer's experience are a multiplicity of interactive applications, advertisements, and information each ostensibly of interest to the consumer and competing for consumer attention. Accordingly, an operator's infrastructure might include the capability to handle one or more of:
a. advertising insertion by the delivery operator at a central, regional or local headend or distribution node facility using, e.g., personalized advertising;
b. the inclusion of additional information, such as program guide data, hyperlinked television content, executable software;
c. signalling and control mechanisms implemented using entertainment device controls; and
d. the integration of television content and a web browser.
   Moreover, the use of data storage devices at the customer's location, as exemplified by digital video recorders, complicates the experience yet further by presenting choices including previously recorded, downloaded, and downloadable media, in addition to scheduled media. Accordingly, a need exists for methods and apparatus that allow users to make choices among stored, downloadable, and scheduled media.

Prior art techniques for monitoring and measuring audience behavior have been limited to methods that infer what the observed consumer was thinking, needing, or wanting from the user's channel selections or depressions of remote control buttons. Better analytic results and insights are possible where it is possible and cost effective to detect and measure a decision-maker's thinking immediately prior to an observable behavior. Therefore, a need exists for methods and apparatus that shift the point and time of observation from traditionally measured behaviors to the momentarily earlier and more nuanced thought which often leads to that behavior.

### SUMMARY OF THE INVENTION

The present invention relates to methods and apparatus for the recognition and processing of spoken requests. In brief overview, spoken sounds are received, identified, and processed for identifiable and serviceable requests. In some embodiments, noise cancellation techniques using knowledge of the ambient environment facilitate this processing.

In various embodiments, processing is facilitated by one or more stages of voice and/or speech recognition processing, by one or more stages of linguistic interpretation processing, and by one or more stages of either state or state-less processing, producing intermediate forms, including text and semantic representations. Ultimately the results of this processing are commands to consumer entertainment devices, network service platforms, or information systems. In some embodiments, this processing is facilitated by information and methods that are attuned to one or more regional speech patterns, dialects, non-native speaker affects, and/or non-English language speech which may be employed in a single customer's premises (CP) device or among a universe of such CP devices. In other embodiments, processing is facilitated by rendering one or multiple commands, including by type, but not limited to, commands otherwise issuable via manual operation of a remote control device, as may be required to fulfill a user intention and request.

If the processing of the spoken sounds fails to yield requests that are identifiable or serviceable by the equipment in the customer's premises, then the spoken sounds, in either a fully processed, partially processed, or unprocessed state, are transmitted to equipment, either elsewhere on the CP or off premises, for further processing. The equipment applies more sophisticated algorithms, alternative reference databases, greater computing power, or a different set of contextual assumptions to identify requests in the transmitted sounds. Requests identified by this additional processing are processed at a remote site or, when appropriate, are returned to the CP system for processing. This arrangement is suited to several applications, such as the directed viewing of television content by channel number, channel name, or program name; the ordering of pay-per-view or multimedia-on-demand programming; and generalized commerce and command applications.

The speech recognition process optionally provides the identity or identity classification of the speaker, permitting the retrieval of information to provide a context-rich interactive session. For example, spoken phonemes may be compared against stored phonemes to identify the speaker, and the speaker's identity may be used as an index into stored information for retrieving the speaker's age or gender, a list of services to which the speaker subscribes, a historical database of the speaker's commercial transactions, stored preferences concerning food or consumer products, and other information that could be used in furtherance of request processing or request servicing.

In one aspect, the present invention relates to an apparatus that permits a user to obtain services using spoken requests. The apparatus includes at least one microphone to capture at least one sound segment, at least one processor configured to identify a first serviceable spoken request from the captured segment, and an interface to provide a communication related to the captured sound segment to a second processor. The second processor is configured to identify a second serviceable spoken request from the communication. The processor transmits the communication to the second processor for further identification. A second apparatus may be operated in response to a command received in response to the first or second serviceable spoken request, or both.

In one embodiment, the apparatus also includes a second interface configured to receive information concerning an audio signal to be used for noise cancellation. The transmitted communication may include at least one phoneme, possibly in an intermediate form. The first and second serviceable spoken requests may be the same, or they may be different.

In another aspect, the present invention relates to a method for processing a spoken request. The method includes identifying a serviceable spoken request from a sound segment, transmitting a communication related to the sound segment for further servicing, and operating an apparatus in response to a command received in response to the communication.

The transmitted communication may include at least one phoneme, possibly in an intermediate form. In one embodiment, the method also includes the use of stored information to determine the identity of the speaker of the sound segment, or the use of stored information to determine a characteristic associated with the speaker of the sound segment. Determined identity may be used to employ stored information concerning the speaker's identity or preferences.

In another embodiment, the method also includes the application of noise cancellation techniques to the sound segment. In one embodiment, a relationship is determined between information concerning an audio signal and the sound segment, and the relationship is utilized to improve the processing of a second sound segment.

In still another aspect, the present invention relates to a method for content selection using spoken requests. The method includes receiving a spoken request, processing the spoken request, and transmitting the spoken request in an intermediate form to equipment for servicing. The equipment may be within the same premises as the speaker issuing the spoken request, or the equipment may be outside the premises.

In one embodiment, the method includes receiving a directive or prototypical command for affecting selection of a program or content channel specified in the spoken request. In another embodiment, the method includes receiving a streamed video signal containing the program or content channel specified in the spoken request. In still another embodiment, the method includes executing a command for affecting the operation of a consumer electronic device in response to the spoken request. In yet another embodiment, the method includes executing a command for affecting the operation of a home automation system in response to the spoken request. In a further embodiment, the method includes playing an audio signal (e.g., music or audio feedback) in response to the spoken request. In another embodiment, the method includes processing a commercial transaction in response to the spoken request. In still another embodiment, the method includes executing a command proximate to the location of the speaker issuing the spoken request. In yet another embodiment, the method includes interacting with additional equipment to further process the transmitted request; the interaction with additional equipment may be determined by the semantics of the transmitted request.

In still another embodiment, the method includes executing at least one command affecting the operation of at least one device or executable code embodied therein in response to the spoken request; this plurality of devices may be geographically dispersed. Exemplary devices include set top boxes, consumer electronic devices, network services platforms, servers accessible via a computer network, media servers, and network termination, edge or access devices. The plurality of devices may be distinguished using contextual information from the spoken requests.

In still another aspect, the present invention relates to a method for content selection using spoken requests. A spoken request is received from a user and processed, and a plurality of possible responses corresponding to the spoken request are determined. After determination, a selection of at least one response from the plurality is received.

In one embodiment, the spoken request is a request for at least one television program. In another embodiment, the spoken request includes a brand, trade name, service mark, or name referring to a tangible item or an intangible item. The plurality of possible responses may include: issuing a channel change command to select a requested program, issuing at least one command to schedule the recording of a requested program, issuing at least one command to order an on-demand version of a requested program, issuing at least one command to affect a download version of a requested program, or any combination thereof. When the spoken request includes a brand, trade name, service name, or other referent, the plurality of responses includes at least one channel change command for the selection of at least one media property associated with the spoken request.

In one embodiment, the plurality of responses is visually presented to the user, and the user subsequently selects one response from the presented plurality; the plurality of responses may also be presented audially. The selection of the response may be made using contextual information.

In yet another aspect, the present invention relates to a method for content selection using spoken requests. A spoken request is received from a user and processed. At least one command is issued in response to the spoken request, and an apparatus is operated in response to the command. The issued command may, for example, switch a viewed media item to a higher-definition version of the viewed media item or, conversely, switch a viewed higher-definition media item to a lower-definition version of the viewed media item.

In still another aspect, the present invention relates to a method for equipment configuration. A sound segment is transmitted in an intermediate form and is processed to identify at least one characteristic. The at least one characteristic is used for the processing of subsequent sound segments. Characteristics may be associated with the speaker, room acoustics, consumer premises device acoustics, ambient noise, or any combination thereof.

In one embodiment, the characteristics are selected from the group consisting of geographic location, age, gender, biographical information, speaker affect, accent, dialect and language. In another embodiment, the characteristics are selected from the group consisting of presence of animals, periodic recurrent noise source, random noise source, referencable signal source, reverberance, frequency shift, frequency-dependent attenuation, frequency-dependent amplitude, time frequency, frequency-dependent phase, frequency-independent attenuation, frequency-independent amplitude, and frequency-independent phase. The processing may be fully automated or, in the alternate, human-assisted.

In another aspect, the present invention relates to a method for speech recognition. The method includes the recording of a sound segment, the selection of configuration data for processing the recorded sound segment, and using the selected data to process additional recorded segments.

In one embodiment, the configuration data is selected utilizing a characteristic identified from the recorded sound segment. The selected data may be stored in a memory for use in further processing. In one embodiment, the configuration data is received from a source, possibly periodically, while in another embodiment the configuration data is derived from selections made from a menu of options, and in still another embodiment the configuration data is derived from a plurality of recorded sound segments. In still another embodiment, the configuration data change as a function of time, time of day, or date.

In still another aspect, the present invention relates to a method for processing spoken requests. A command is issued resulting in the presentation of content available for viewing. In response to this issued command, an apparatus is activated for processing spoken requests. A spoken request is received and, after it is processed, the apparatus is deactivated.

In another aspect, the present invention relates to an apparatus that permits a user to obtain services using spoken requests. The apparatus includes at least one microphone to capture at least one sound segment, at least one processor to identify a serviceable spoken request from the captured segment, and an interface for providing communications related to the sound segment to equipment, wherein the processor is configured to identify the serviceable spoken request using speaker-tailored information. The speaker-tailored information varies by gender, age, or household.

In yet another aspect, the present invention relates to an electronic medium having executable code embodied therein for content selection using spoken requests. The code in the medium includes executable code for receiving a spoken request, executable code for processing the spoken request, executable code for communicating the spoken request in an intermediate form; and executable code for operating an apparatus in response to a command resulting at least in part from the spoken request.

In further embodiments, the medium also includes executable code for receiving a command for affecting selection of a program or content channel specified in the spoken request, executable code for executing a command for affecting the operation of a consumer electronic device in response to the spoken request, executable code for executing a command proximate to the location of the speaker issuing the spoken request, executable code for executing a plurality of commands affecting the operation of plurality of devices in response to the spoken request, or some combination thereof.

In still another aspect, the present invention relates to an apparatus that permits a user to obtain services using spoken requests. The apparatus includes at least one microphone to capture at least one sound segment, at least one processor configured to identify a serviceable spoken request from the capture segment, and a transceiver for communications related to the configuration of the apparatus, wherein the processor identifies serviceable spoken requests from the captured segment using information received from the transceiver. In one embodiment, the apparatus receives configuration data from remote equipment. In another embodiment, the configuration data is received indirectly through another apparatus located on the same customer premises as the apparatus.

In yet another aspect, the present invention relates to a method of controlling at least part of a speech recognition system using configuration data received from remote equipment in connection with speech recognition. The configuration data may be received from equipment located off the premises.

As described below, in yet another aspect the invention provides a method for the monitoring of user choices and requests, including accumulating data representative of at least one spoken request, and analyzing the accumulated data.

The foregoing and other features and advantages of the present invention will be made more apparent from the description, drawings, and claims that follow.

### BRIEF DESCRIPTION OF DRAWINGS

The advantages of the invention may be better understood by referring to the following drawings taken in conjunction with the accompanying description in which:

FIG. 1 presents a diagram of a prior art CP system for the receipt and display of cable content from a DSO;

FIG. 2 illustrates an embodiment of the present invention providing a CP system for the recognition and servicing of spoken requests;

FIG. 3A depicts an embodiment of a client agent for use in a customer's premises in accord with the present invention;

FIG. 3B shows another embodiment of a client agent for use in a customer's premises in accord with the present invention;

FIG. 3C depicts still another embodiment of a client agent for use in a customer's premises in accord with the present invention;

FIG. 4A illustrates an embodiment of a voice-enabled remote control unit for use with the client agents of FIG. 3;

FIG. 4B shows a second embodiment of a voice-enabled remote control unit for use with the client agents of FIG. 3;

FIG. 5 presents a diagram of an embodiment of a system operator's premises equipment for the recognition and servicing of spoken requests; and

FIGS. 6A and 6B depict an embodiment of a method for providing services in response to spoken requests in accord with the present invention.

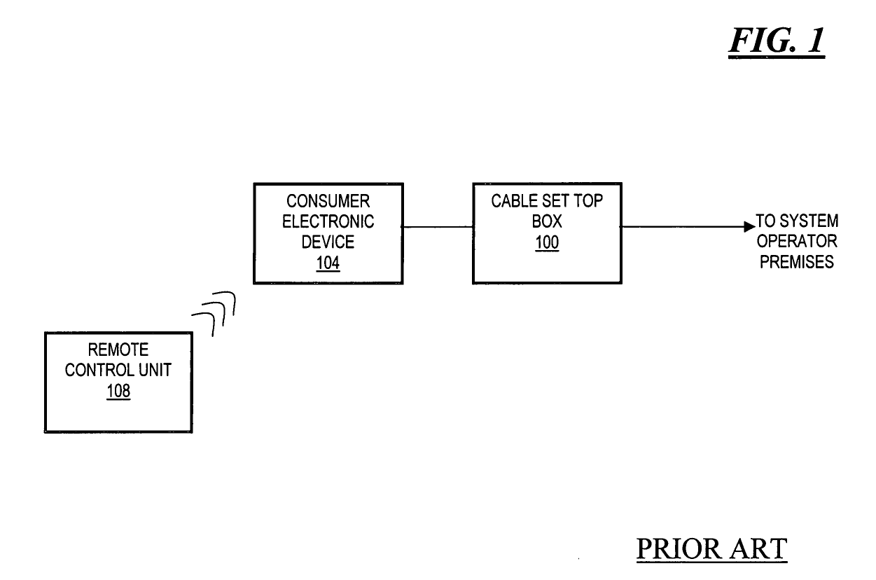

In the drawings, like reference characters generally refer to corresponding parts throughout the different views. The drawings are not necessarily to scale, emphasis instead being placed on the principles and concepts of the invention.

### DETAILED DESCRIPTION OF THE INVENTION

In general, the present invention lets a user interact with audiovisual, graphical, and textual content or a combination thereof displayed on a consumer electronic device, such as a television, through spoken requests. Some of these requests are formed from keywords drawn from a set of frequently-used command names. Since these requests use a finite and limited vocabulary, a CP system in accord with the present invention has sufficient computing resources to process these requests in a speaker-independent fashion and to service the requests in real-time using appropriate commands to the CP equipment (CPE).

This finite vocabulary may be embedded in the CPE at its time of manufacture. For example, manufacturers could embed vocabulary related to virtual remote control commands such as “channel up” and “channel down.” Mechanisms in the CPE may allow for the augmentation of the finite vocabulary by, e.g., configuration of the CPE by an end user, downloads of additional vocabulary or the addition of frequently used commands experienced in the actual operation of the CPE. Accordingly, an end user may configure his CPE to recognize broadcast station names and cable channels available to his CPE, or the CPE may receive such programming (including, e.g., program title names) from a content provider.

The remainder of these requests use an essentially open-ended vocabulary, involving words and phrases outside the set of frequently-used commands. Processing this latter category of requests in real-time, in a speaker-independent fashion, typically requires computing resources beyond that of a reasonably cost-effective CP system. Accordingly, these open-ended requests may be transmitted by the CP system to other equipment at the customer's site, for example, as a digital representation of a collection of phonemes, or upwire to a service operator's premises (SOP) equipment where the requests are processed, serviced, or, when necessary, returned to the CP system for servicing.

For clarity, throughout this discussion the word “request” refers to the sounds uttered by a user of the system, and the word “command” refers to one or more signals issued by a device to effect a change at a CP, SOP, or other device. According to a typical embodiment of the present invention, a spoken “request” becomes one or more “commands” that effect changes on CP, SOP, or other equipment.

The terms “directives” or “intermediate forms” refer to one or more derivative representations of an original sound form, the sound's source and/or context of presentation, and methods or means of its collection. Such intermediate forms may include, but are not limited to, recordings, encodings, text, phonemes, words, metadata descriptive information, and semantic representations. In accord with a typical embodiment of the present invention, a “request” that is not fully processed locally may be converted into a “directive” or “intermediate form” before it is transmitted to other equipment for further processing.

For additional clarity, the terms “channel” or “change channel” as used herein are logical terms applying equally to frequency divided channels and tuners as to other schema for subdividing and accessing subdivided communication media, including but not limited to time-division multiplexed media, circuit switched media, and cell and packet switched and/or routed media whether or not routed as in the example of a Group Join using one or more versions of Internet Protocol. However, implementation in any particular communication network may be subject to standards compliance.

System Overview

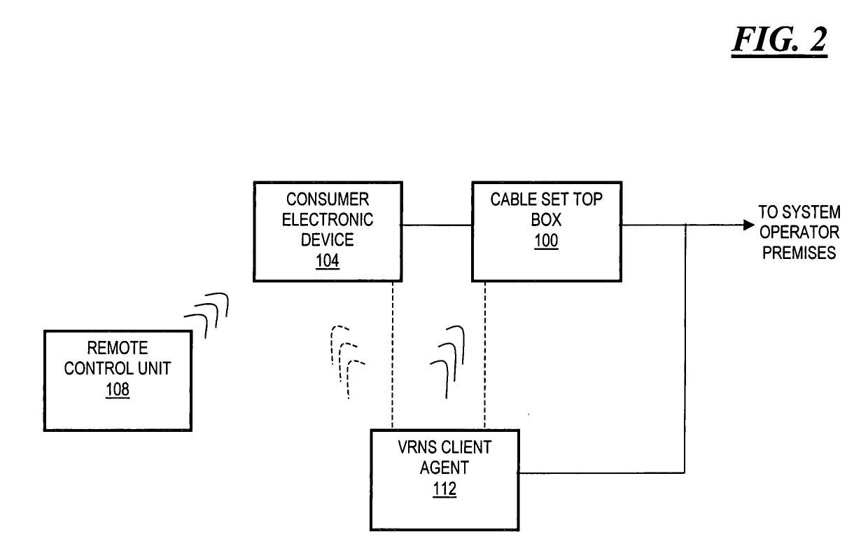

FIG. 2 presents one embodiment of a CP system that responds to a user's spoken requests for service. One or more cable system set top boxes 100 on the customer's premises are in electrical communication with a consumer electronic device 104—such as a flat-screen or projection television—through, for example, a wired co-axial connection or a high-bandwidth wireless connection. When in use, the remote control unit 108 is in wireless communication with device 104, the set top box 100, or both, as appropriate.

It is to be understood that these specific device types are only exemplary. One or more set top boxes 100 may relate to other delivered services, such as direct broadcast satellite or digital radio. One or more consumer electronic devices 104 may relate to audio, as would an audio amplifier, tuner, or receiver, or relate to a stored media server, as would a personal computer, digital video recorder, or video cassette player/recorder.

In this embodiment, a client agent 112 providing voice-recognizing network services (VRNS) is connected to the set top box 100 using wired or wireless links. The client agent 112 uses additional wired or wireless links to communicate with consumer electronic device 104, facilitating certain types of local commands or noise-cancellation processing. Like the set top box 100, this embodiment of the client agent 112 is also in communication with upstream cable hardware, such as the cable head-end or other SOP equipment, using a co-axial connection. In other embodiments, the client agent 112 is in communication with upstream hardware using, for example, traditional telephony service (POTS), digital subscriber loop (xDSL) service, fiber-to-the-home (FTTH), fiber-to-the-premises (FTTP), direct broadcast satellite (DBS), and/or terrestrial broadband wireless service (e.g., MMDS) either singly or in combination. In still other embodiments, the client agent 112 is additionally in communication with a local area network servicing the customer's premises, such as an Internet Protocol over Ethernet or IEEE 802.11x network.

Of course, the illustration and discussion of a separate set top box 100, a separate electronic device 104, and a separate client agent 112 in FIG. 2 and throughout this application merely facilitates discussion of the present invention. There is no requirement that the set top box 100, the device 104, and the client agent 112 be separate physical entities. Instead, it is explicitly contemplated that a single unit (such as a personal computer) or a plurality of units will provide, for example, the functionality of the set top box 100, the device 104, and the client agent 112, or any sub-combination thereof. The invention is similarly independent of particular implementation choices as to communication technology, communication path, cable channel or frequency band, signaling discipline, and transport protocols.

In various embodiments, the functionality of the client agent 112 is provided as a set top box, an under-the-cabinet appliance, or a personal computer on a home network. The functionality provided by the client agent 112 may also be integrated with a digital cable set-top box, a cable-ready television, a video cassette player (VCP)/recorder (VCR), a digital versatile disk (DVD) player/recorder (DVD- or DVD+formats), a consumer-oriented home entertainment device such as an audio compact disc (CD) player, or a digital video recorder (DVR). In some embodiments, client agent functions are located, rather than near a cable set top box 100, adjacent to or integrated with a home gateway box capable of supporting multiple devices 112, as present in some DSO networks using very-high-bitrate digital subscriber line (VDSL) technology.

It is also to be understood that the illustrated relationship of one client agent 112 to one consumer electronic device 104 or to one cable set top box 100 is merely exemplary. There is no practical limitation as to the number of boxes 100 or devices 104 that a client agent 112 supports and controls, and with appropriate programming a single client agent 112 can duplicate the functionality of as many remote control units 108 as memory or storage allows to facilitate the control of devices 104 and/or boxes 100.

The client agent 112 may distinguish among connected devices 104 or boxes 100 using contextual information from a spoken request. For example, the request may include a name associated with a particular device 104, e.g., “Change the Sony,” “Change the good t.v.,” or “Change t.v. number two.” Alternately, the contextual information may be the very fact of the spoken request itself: e.g., when a command is issued to change a channel, the agent 112 determines which of the devices 104 is currently displaying a commercial and which of the devices 104 are currently displaying programming, and the channel is changed on that device 104 displaying a commercial.

In operation, the consumer electronic device 104 displays audiovisual programming from a variety of sources for listening and/or viewing by a user. Typical sources include VHF or UHF broadcast sources, VCPs or DVD players, and cable sources decoded with set top box 100. Using a remote control 108, the user issues commands that direct the set top box 100 to change the programming that is displayed for the user. Typically, key-presses on the remote control 108 are converted to infrared signals for receipt by the set top box 100 using a predetermined coding scheme that varies among the various brands and models of consumer electronic devices 104 and/or set top boxes 100. The user also issues similar commands directly to the device 104, using either a separate remote control 108′ or a universal remote control that provides the combined functionality of multiple remote controls 108.

The presence of the client agent 112—or equivalent functionality in either the set top box 100 or the device 104—permits the user to issue spoken requests for services. These spoken requests are processed and serviced locally, remotely, or both, depending on the complexity of the request and whether the CPE is capable of servicing the request locally. For example, as illustrated in FIG. 2, typical embodiments of the client agent 112 include wired or wireless connections for communication with the set top box 100 or the consumer electronic device 104. Using these connections, a client agent 112 locally services requests that only require the issuance of commands to the box 100 or the device 104, such as commands to raise or lower the volume of a program, or to change the channel. As discussed below in greater detail, the client agent 112 may also transmit a fully processed request to other hardware for servicing alone (e.g., delivering a multimedia-on-demand program without any further processing of the request) or for further processing of the request.

More specifically, each spoken request coming from a user is composed of sound segments. Some of these sound segments belong to a specified set of frequently-used sound segments: e.g., numbers or keywords such as “volume,” “up,” “down,” and “channel.” These frequently-used sound segments map onto the functionality provided by the CPE. That is, since the CPE typically lets a user control the volume and channel of the program that is viewed, one would expect a significant number of spoken requests to be directed to activating this functionality and, therefore, the frequently-used sound segments would include segments directed to activating this functionality.

Since it may be impractical to attempt speech recognition at the level of individual sound segments or words, or it may be economically advantageous to otherwise divide or organize processing, the sound segments may be further organized into phonemes. In one embodiment, speech recognition at the CPE occurs at the level of individual phonemes. Once individual phonemes are recognized, they are aggregated to identify the words contained in the sound segments. The identified words may then be translated into appropriate commands to operate the CPE.

In one embodiment, the CPE maintains a library of phonemes and/or mappings from sound representative intermediate forms to phonemes (i.e., together “models”), which may be shared or individually tailored to each of the speakers interacting with the CPE, and in some embodiments, a list or library of alternative models available. This information not only facilitates the processing of sound segments by the CPE, but also permits the classification and/or identification of each speaker interacting with the CPE by, for example, identifying which model from a library of models best matches the sound segments currently received by the CPE. The library providing the best match identifies the speaker associated with the library and also facilitates the recognition of other requests issued by that speaker.

The identity of the speaker may, in turn, be used to obtain or infer other information, for example, to facilitate the processing of the spoken segments, such as the speaker's gender, age, shopping history, or other personal data or preferences. When the CPE interacts with a new speaker, it may generate or retrieve a new speaker-specific model from a library of models, using those requests received in the interaction or one or more intermediate forms for future processing, and may purge speaker-specific models that have not been used more recently. The CPE may maintain, for example, the information as to which speakers are, from time to time, present and thus eligible for recognition processing, even though such present person may not be speaking at a particular moment in time. In some embodiments, such presence or absence information may be used to facilitate the processing of requests.

This system provides an alternative to speaker-dependent speech recognition systems that require an extended training period. That is, CPE in accord with the present invention may initially attempt speech recognition using a neutral or wide-spectrum phoneme and mapping library or a phoneme and mapping library associated with another speaker. As spoken segments from a new user are processed and recognized, the recognition information, for example confidence scores, may be used in part to facilitate the construction and improvement of the installed or a new speaker-dependent phoneme and mapping library, for example as with a resulting confidence feedback loop. In one embodiment, the CPE provides for a configuration option whereby the a speaker may select a mapping library tailored to perform better for a subset of the potential universe of speakers, for example, choosing a model for female speakers whose first language was Portuguese and who have used North American English as their primary language for thirty or more years. In still another embodiment, the CPE provides an explicit training mode where a new speaker “trains” the CPE by, e.g., reading an agreed-upon text.

In various embodiments of the invention, phoneme recognition and speaker identification occur at the client agent 112, at another piece of equipment sited at the customer's premises, at an off-site piece of equipment, or at some combination of the three.

Some spoken requests will consist of sound segments that are not readily recognized by the CP system. Some of these requests will be “false negatives,” i.e., having segments in the set of frequently-used segments that should be recognized, but are not recognized, for example, due to excessive noise or speaker inflection. The remaining requests consist of segments that are not found in the set of frequently-used segments, e.g., because they seek to activate functionality that cannot be serviced by the CPE alone. These requests tend to be open-ended in nature, requiring information or processing beyond that available from the CPE. Typical examples of this latter type of request include: “I want to see Oprah” or “I want to buy that hat, but in red.”

Due to the open-ended nature of these latter requests and the vocabulary used, these requests may not be suited to real-time, speaker-independent processing and servicing using the computing resources available at the customer's premises and, specifically, in the client agent 112. Cost-effective client agent design typically requires that the client agent have no more than adequate computing resources to process locally-serviceable commands. Although it is anticipated that the amount of such resources affordably located locally will increase over time and the absolute amount and diversity of requests able to be processed locally will increase, the additional resources presently required to do open-ended, real-time, speaker-independent speech recognition could make the client agent 112 as expensive as a high-end personal computer.

Accordingly, CPE constructed in accord with the present invention recognizes when the equipment cannot process and service a spoken request. Where network access is available, the CPE forwards these requests to other equipment at the customer's site or to a remote facility (such as a SOP located at a cable head-end) having the additional computing resources needed to perform open-ended, real-time, speaker-independent request processing and servicing. In one embodiment, the request is transmitted as a digital representation of a collection of phonemes. After the requests are processed, appropriate directives and/or commands are issued to service these requests either using the viewer's CPE or the SOP equipment, as discussed in greater detail below.

Alternately, when the time to remotely process the spoken segments—including the round trip communications time between the client agent 112 and a remote facility—is less than the time required to locally process the spoken segments, the spoken segments may be transmitted directly to the remote facility without any local processing being performed on the spoken segments. The time required for local processing and remote processing may be compared initially or on an on-going basis, allowing for dynamic load balancing, for example, to facilitate response when the remote facility becomes heavily loaded from servicing too many client agents 112. The client agent 112 may similarly route spoken segments to other equipment at the customer's site when the time required to process the spoken segments at the site equipment (including round-trip communications time) is less than the time required to process the segments at the client agent 112. In embodiments where such transmission provides for a duplication, distribution, or parallelization of one or more processing tasks, the present invention employs remote signaling methods to trim or flush one or more processing threads, for example upon first-completion of a task so allocated to the supporting technical infrastructure.

Exemplary Interactions with Embodiments of the System

In operation, embodiments of the present invention may be used for the presentation and navigation of electronic program guide information and choices. Such presentation and navigation include a capability to map any one of multiple forms of a spoken request onto a single referent. More specifically, a typical many-to-one-mapping in accord with the present invention involves the mapping onto a single broadcast station from the station's name, the station's call letters, the channel number assigned by a regulatory entity to the station's use of over air spectrum, the ATSC sub-channel numbering employed by the station operator, or a channel or sub-channel number assigned or used by a non-regulatory entity such as a cable television operator to refer to the station's assignment in a distribution media such as cable. For example, in one installation of one embodiment in the Greater Boston area, the spoken requests “WBZ”, “CBS,” or “Channel 4” all result in a “Change Channel” directive with the directive argument or value of “4”.

Embodiments of the present invention use information available in the context of an interaction to distinguish similarly sounding requests and the referents to which they refer which, in a different type of system, could result in high speech recognition error rates and/or unintended consequences. Further to the previously described example, a user of an installation of one embodiment in the Greater Boston area subscribes to Comcast's digital cable services and owns a digital television set equipped with a high definition tuner. The station WGBH has an over-air channel assignment at channel 2, a cable system assignment at channel 2, and “WGBH DT” has cable channel number 802. Tuning to one of these channel selections entails commanding the cable set top box's tuner to either channel 2 or 802, respectively. WGBX is operated by substantially the same parent organization as WGBH. WGBX is a station assigned the over-air channel of 44 and is marketed using the brand “GBH 44”. “WGBX DT” has no corresponding cable channel on the Comcast system, although it is a valid reference to an over-air channel. A user wanting to watch a program on “PBS” would have to select one of these many options.

Further complicating these choices are procedural differences between accessing channels on cable systems and accessing over-air channels. In the described example, changing the channel to the over air version of WGBX DT cannot be accomplished using the cable set top box and instead requires a tuner manipulation procedure employing an over-air DTV or HDTV tuner conforming to standards of the ATSC, wherein two channel number digits are followed by a separator character, often “Dot” or “Dash”, followed by the two sub-channel numbers, which in this example would be “1”. For some ATSC-compliant tuners, the “Dot” appears prefixed—not infixed—in the procedure.

In contrast, an exemplary embodiment of the present invention responds to the request for “WGBX” by looking up the station number, observing that the request can be best satisfied by use of the cable service, and issuing the commands to the cable set top box to Change Channel to cable channel 44. The normative response to a request for “WGBX DT” is to perform the same lookup, observe that the request can only be fulfilled by over-air channel 44<Dot>1, and issue the commands to switch out of cable source mode, to switch into over-air broadcast mode, and to tune the high definition receiver using the ATSC-compliant prototypical command form “4”, “4”, “Dot”, “0”, “1”. Were WGBX DT available on the cable channel lineup, the normative response would not have had to switch to over-air reception, though a user customizable setting may have set that as a preference.

In one embodiment of the invention, requests for a program or channel that could be fulfilled with a high definition or a standard definition alternative are assigned an installation specific behavior. One such behavior is to always choose the high definition alternative when available and equivalent, as in responding with a set top box change channel to 802 in the face of a request for “WGBH”. Another behavior is to always choose the standard definition alternative unless the high definition alternative is explicitly requested, as in “WGBH DT”. Still another behavior is to choose the high definition alternative when the programs airing on the alternatives are considered equivalent. Certain embodiments of the present invention implement a virtual button, e.g., “High Def”, which automatically changes the current station to the high definition version of the then-currently tuned-to station or program. Where such a station does not exist, audio feedback informs the requestor of that fact. Where the user's electronic device is not technically capable of fulfilling the request, as in the absence of a high definition tuner, the requester is informed, for example, by audio message.

In operation, embodiments of the present invention may also be used to search in response to a single request through a wide variety of descriptive data, for example, including but not limited to program or episode titles, categories of subject matter or genre, names of characters, actors, directors, and other personages. When a single matching referent is identified as the result of the search, a normative response is to retune the entertainment device to the corresponding channel number. When multiple-matching referents are identified as the result of the search, one embodiment stores these referents in a short list which may be read aloud, viewed, or selected, for example in “round robin” fashion. In some embodiments, navigation of such a short list is by a synthetic virtual button request, such as “Try Next” or “Try Last”.

In some embodiments, entries made to a short list facility are sorted in a particular order, e.g., an order reflecting the user's expressed preference. The order may reflect characteristics of the titles selected, for example, but not limited to, by decreasing episode number or age, or by a categorization of specials versus episodes versus movies versus season opener. The order may reflect preferences of the network operator or any of the many businesses having influence over the program or advertising inserted during the airing or playout of the program. The order may reflect behavioral aggregates, as in a pick-list derived from program ratings, or may result from either an actual record of prior viewings or a probability calculation as to whether or not the viewer has already seen or might be interested in one or more particular entries in such a list.

In some embodiments, when a request spawns a search that fails to identify any currently-available referents, the request and any associated directives may be stored in a memory for later resolution and the issuance of one or more resultant commands may be deferred to one or more later times or incidents of prerequisite events. For example, a request to “Watch The West Wing” made at 7:00 pm Eastern Daylight Time on a Monday is understood by the system but may be unable to be fulfilled using broadcast entertainment sources until sometime later. In such cases, the invention may report the delay to the user and offer a menu of alternatives for the user's selection. One such alternative is to automatically change channels to the requested program when the program becomes available, ensuring first that the required devices are powered. A second alternative is to automatically record the requested program when the program becomes available, should a VCR or DVR be present locally. A third alternative is for the system to issue commands resulting in play-out of the same program title and episode from a network resident stored-video server or in it being recorded there on behalf of the user. A fourth alternative is for the system to suggest one or more other programs or entertainment sources, such as a program stored on a DVR or a video-on-demand service, or digitally-encoded music stored on the hard drive or CD-ROM drive of a CPE computer. These being only examples, other alternatives can be available using these same capabilities of the present invention.

In some embodiments, request processing relies on rules, heuristics, inferences and statistical methods applied to information both as typically found in raw form in an interactive program guide and as augmented using a variety of data types, information elements, and methods. Examples of this include related-brand inferences made with respect to the extension brand names owned by HOME BOX OFFICE, e.g., TWO, PLUS, SIGNATURE, COMEDY, FAMILY, DIGITAL, and ZONE, and the relationship between analog or standard definition broadcast and digital or high definition broadcast channels operated by related entities, e.g., station call letters WGBH, WGBH-DT, WGBX-DT, and WGBX-DT4, where appropriate, but not the cases of station call letters KJRE, KJRH, and KJRR. These inferences may be made using, for example, information concerning the user's subscription information and past viewing habits, both in the aggregate and on a time and date specific basis. In another example, inferences may be drawn based on the location of the CP and/or DSO facilities, whether absolute or relative to other locations, for example, locations of broadcast station transmitters or downlink farms.

To facilitate these interactions in some embodiments, augmentation is applied to program guide information prior to its transmission to the CP. For example, a related-brand field associating a brand bundle comprised of MTV, VH-1, CMT, and other music programming sub-brands owned by Viacom may be added to the program guide information at the head end. In other embodiments, augmentation is effected at the CP, for example, by associating the nicknames of sports teams with the team line-up published in the program guide, thereby allowing the system to intelligently respond to a user's spoken request to “Watch Huskies Basketball” in cases where a correct channel inference may not otherwise be possible using unaugmented program guide data. The data added to the program guide information may be obtained from the service operator, as with provisioning information; from the user, as with names, biographical, and biometric information; or from third parties. The augmenting information may made available, for example, to the invention at the CP without integration with the fields currently understood as associated with interactive program guides. For example, data characterizing the viewing preferences of audience segments may be used to build a relevant list for response to an otherwise ambiguous request from a user to “Watch Something On TV”.

In some embodiments, such presentation and navigation is accomplished without conveyance to the speaker of program guide and choice information immediately prior to a request. In some embodiments, such conveyance occurs afterward, as in a confirmation of a request. In other embodiments, such conveyance occurs prior to, but not temporally proximate to a corresponding request. In still other embodiments, conveyance immediately precedes a related request. In other embodiments, where the invention includes a visual or textual display capability, for example through additional hardware or by integration with a set top box, such conveyance may be visually rendered.

As a user may find it desirable to deactivate a speech-operated client agent 112, particular embodiments of the client agent 112′ allow for the receipt of commands by voice, e.g., “Stop Listening”, or from the remote control 108 that activate or deactivate the agent 112′. Such deactivation may also be accomplished upon expiration of a timer. Other embodiments of client agent 112″ receive commands from the box 100 that activate or deactivate the agent 112″. For example, a user may instruct the set top box 100 to display an electronic program guide. Upon selecting the electronic program guide, the set top box 100 issues an instruction to the client agent 112″ that causes it to monitor ambient sound for spoken requests. When the client agent 112″ finishes processing a spoken request by, for example, issuing a command to the set top box 100 causing it to select a particular channel for viewing, the set top box 100 may issue a command to the agent 112″ that causes it to cease monitoring ambient sound for spoken requests. Alternately, the issuance of a command to the box 100 from the agent 112″ does not cause the box 100 to deactivate the agent's 112″ monitoring, but the deselection of the electronic program guide does cause the box 100 to deactivate the agent's 112″ monitoring functionality.

Hardware-Based Embodiments of the Present Invention

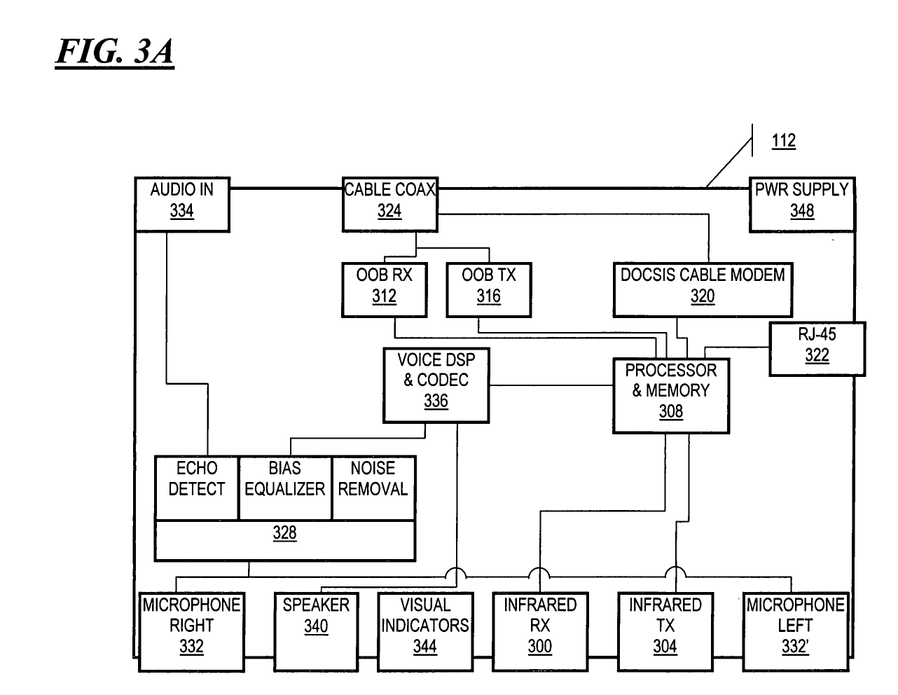

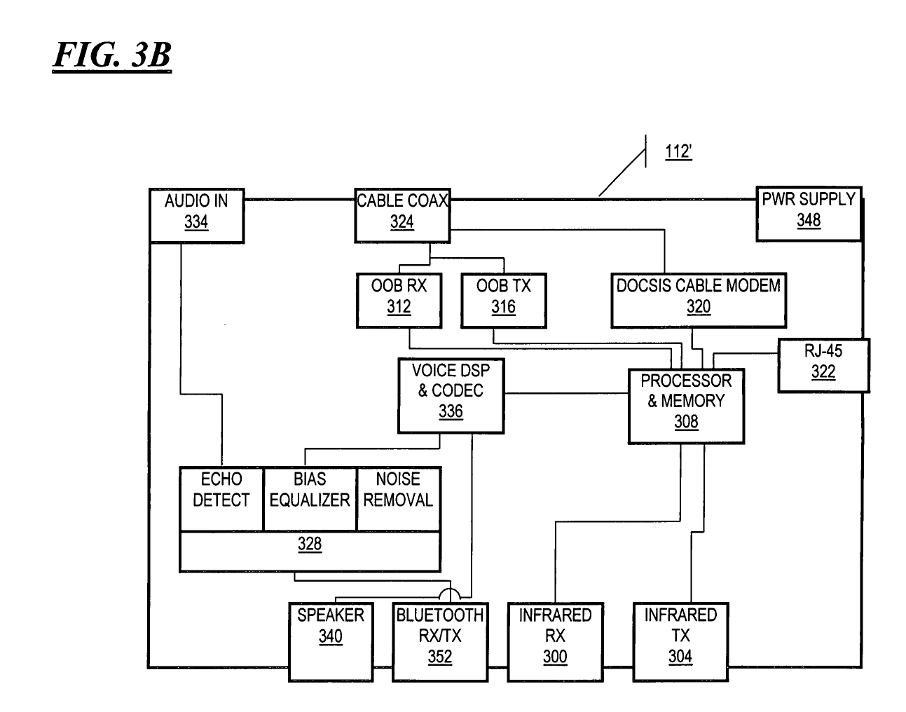

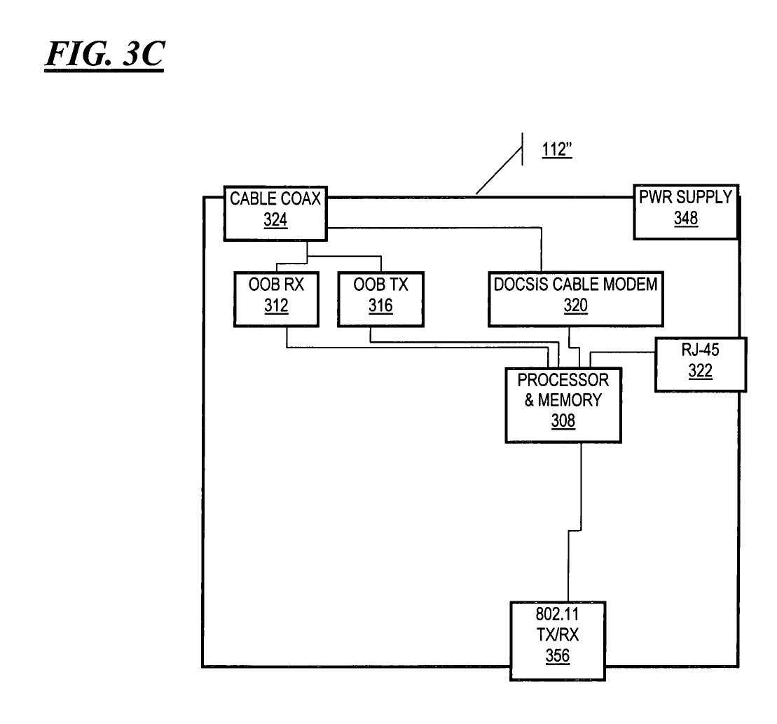

FIG. 3A presents an embodiment of a client agent 112 for use with the present invention. Infrared receiver (RX) 300 and infrared transmitter (TX) 304 are in communication with the agent's processor and memory 308. The processor and memory 308 are additionally in communication with the out-of-band receiver (OOB RX) 312, the out-of-band transmitter (OOB TX) 316, and/or a cable modem 320 compliant with the data-over-cable service interface standard (DOCSIS). The OOB RX 312, the OOB TX 316, and/or the cable modem 320 are in communication with SOP equipment through the coaxial port 324. The processor and memory 308 are further in communication with a voice DSP and compression/decompression module (codec) 336. The client agent 112 interfaces with a local LAN using RJ-45 jack 322. Through connection to a LAN, the client agent 112 may interface with a gigabit ethernet or DSL connection to a remote site, e.g., for remote processing of spoken commands.

The agent's signal processing module 328 receives electrical waveforms representative of sound from the right microphone 332, the left microphone 332′, and one or more audio-in port(s) 334. The module 328 provides a processed electrical waveform derived from the received sound to the voice DSP and codec 336. The voice DSP and codec 336 provides auditory feedback to the user through speaker 340. The user also receives visual feedback through the visual indicators 344. Power is provided to the components 300-344 by the power supply 348.

Using its infrared receiver 300, the client agent 112 receives power-on and power-off commands sent by a viewer using a remote control unit. Although the viewer intends for the commands to be received by a set top box or a consumer electronic device, the client agent 112 recognizes the power-on and power-off commands in their device-specific formats and may accordingly coordinate its own power-on and power-off behavior with that of the set top box, the device, or both. The client agent 112 similarly uses its infrared transmitter 304 to issue commands in device-specific formats for the set top box and/or the device, in effect achieving functionality similar to that provided by the remote control unit. Of course, the use of infrared transmission is only one form of communication suited to use with the present invention; other embodiments of the client agent 112 utilize wireless technologies such as Bluetooth or IEEE 802.11x and/or wireline technologies such as asynchronous serial communications over RS-232C or OOB packets using RF over coax, these being but a few examples. Where the client agent 112 is substantially integrated within the packaging of consumer electronic device 104 or cable set top box 100, a wired connection or memory communication method may be used. Similarly, the control protocol(s) issued by a client agent 112 are not limited to those carried via infrared. A variety of protocols may also be used in one or more embodiments including, for example but not limited to, carriage return terminated ASCII strings, one or a string of hexadecimal values, and protocols that may include nearby device or service discovery and configuration features such as Apple Computer's Rendezvous.

The processor and memory 308 of the client agent 112 contains and executes a stored program that coordinates the issuance of commands to the set top box 100 and the device 104. Typical issued commands include “set channel to 33,” “power off,” and “increase volume.” The commands are issued in response to spoken requests that are received and processed for recognized sound segments. When sound segments are recognized and the stored program indicates that they are serviceable using the resources local to the customer's premises, the stored program constructs an appropriate sequence of commands in device-specific formats and issues the commands through the infrared transmitter 304 to the set top box or consumer electronic device.

The OOB receiver 312 and OOB transmitter 316 provide a bi-directional channel for control signals between the CPE and the SOP equipment. Similarly, the processor and memory 308 use the DOCSIS cable modem 320 as a bi-directional channel for digital data between the CPE and the SOP equipment. In this embodiment, the OOB and DOCSIS communications are multiplexed and transmitted over a single co-axial fiber through the co-axial connector 324, although it is understood that other embodiments of the invention use, for example, fiber optic, wireless, or DSL communications and multiplexed and/or non-multiplexed communication channels.

The agent's signal processing module 328 receives electrical waveforms representing ambient sound from the agent's microphones 332 and the sound received at the agent's audio-in port 334. The sound measured by the microphones 332 will typically include several audible sources, such as the audio output from a consumer electronic device, non-recurring environmental noises, and spoken requests intended for processing by the client agent 112. The signal processing module 328 detects and removes noise and echoes from the waveforms and adjusts their audio bias before providing a conditioned waveform to the voice DSP and codec 336 for segment recognition. In one embodiment, a series of transformations (e.g., mid-pass filtering, squelch, frequency, and temporal masking) are applied to the measured sound to increase the signal-to-noise ratio for sounds in the frequency range of most human speech—e.g., 0 Hz through 10 kHz—that are most likely to be utterances. Together, these transformations both condition the signal and optimize the bit-rate efficiency of, quality resulting from, and delay introduced by the voice codec implemented, for example, a parametric waveform coder.

In a further embodiment, the signal-processing module 328 employs microphone array technology to accomplish either an attenuation of sound arriving at the microphones from an angle determined to be off-axis, and/or to calculate the angle from which the request was received. In the latter case, this angle of arrival may be reported to other system components, for example for use in sociological rules, heuristics, or assumptions helpful to resolving precedence and control conflicts in multi-speaker/multi-requestor environments.

A consumer electronic device typically includes one or more audio-out connector(s) for connecting the device to, e.g., an amplifier or other component of a home entertainment system for sound amplification and playout through external speakers. The audio-in connection 334 on the client agent 112 is typically connected to the audio-out connector on such a device. Then, operating under the assumption that a significant source of noise measured by the microphones 332 is the audiovisual programming being viewed and/or listened to using that device, then the signal-to-noise ratio for the signal received by the microphones 332 is improved by subtracting or otherwise canceling the waveform received at the audio-in connector 334 from the waveform measured by the microphones 332. Such subtraction or cancellation is accomplished with either method of design, being either taking advantage of wave interference at the sound collector in the acoustic domain, or using active signal processing and algorithms in the digital domain.

In a further embodiment, the waveform measured by the microphones 332 is compared to the waveform provided to the audio-in connector 334, for example, by correlation, to characterize a baseline acoustical profile for the viewing room. The divergence of the baseline from its presumed source signal is stored as a transform applicable to detected signals to derive a version closer to the presumed source, or vice versa. Typical comparisons in accord with the present invention include inverse time or frequency transforms to determine echoing, frequency-shifting, or attenuation effects caused by the contents and geometry of the room containing the consumer electronic device and the client agent. Then, the stored transforms are applied prospectively to waveforms received at the audio-in connector 334 and the transformed signal is subtracted or in other ways removed from the waveform measured by the microphones 332 to further improve the signal-to-noise ratio of the signal measured by the microphones 332.

This noise-reduction algorithm scales for multiple consumer electronic devices in, e.g., a home entertainment center configuration. The audio outputs of all of these devices may be connected to the client agent 112 to achieve the noise reduction discussed above, either through their own audio inputs 334′ or through a signal multiplexer connected to a single audio input 334″ (not pictorially shown).

Alternately, the audio-in connection 334 can receive its input as digital data. For example, the audio-in connection 334 can take the form of a USB or serial port connection to a cable set-top box 100 that receives digital data related to the audiovisual programming being presented by the set-top box 100. Additionally, the client agent 112 may receive EPG data from the set-top box 100 using the same digital connection 334. In this case, the digital data can be filtered or processed directly without requiring analog-to-digital conversion and additionally used for noise cancellation, as described below.

The voice DSP and codec 336 provides the microprocessor 308 with preconditioned and segmented audio including several segments potentially containing spoken words. Each segment is processed using a speaker-independent speech recognition algorithm and compared against dictionary entries stored in memory 308 in search of one or more matching keywords.

Reference keywords (throughout herein meant to include both “words” and “phrases”) are stored in the memory 308 during manufacture or during an initial device set-up and configuration procedure. In addition, the client agent 112 may receive reference keyword updates from the DSO when the client agent 112 is activated or on an as-needed basis as instructed by the DSO.

Keywords in the memory 308 may be generic, such as “Listen,” or specific to the system operator, such as a shortened version of the operator's corporate name or a name assigned to the service (e.g., “Hey Hazel”). When a keyword or phrase is identified, the system attempts to interpret the spoken request using a lexicon, predicate logic, and phrase or sentence grammars that are either shared among applications or specified on an application-by-application basis. Accordingly, in one embodiment each application has its own lexicon, predicate logic, and phrase or sentence grammars. In other embodiments, applications may share a common lexicon, predicate logic, and phrase or sentence grammars and they may, in addition, have their own specific lexicon, predicate logic, and phrase or sentence grammars. In each embodiment, the lexicon, predicate logic, and phrase or sentence grammars may be organized and situated using a monolithic, hierarchical, indexed key accessible database or other access method, and may be distributed across a plurality of speech recognition processing elements without limitation as to location, whether partitioned in a particular fashion or replicated in their entirety.

In the event that the processor and memory 308 fail to identify a spoken segment, as discussed above, the processor and memory 308 package the sound segment and/or one or more intermediate form representations of same for transmission upstream to speech recognizing systems located outside the immediate viewing area. These systems may be placed within the same right of way, e.g., on another computing node on a home network, or they may be placed outside the customer's premises, such as at the cable head-end or other SOP or application service provider (ASP) facility. Communications with equipment on a home network (such a media server, audio and/or video jukebox, or SS-7 or SIP enabled telephone equipment) may be effected through RJ-45 jack 322 or an integrated wireless communications capability (not shown in accompanying Figures), while communications with an SOP or ASP facility may be effected through the cable modem 320 or the OOB receiver 312/transmitter 316. In one embodiment, the communication to the external equipment includes the results from the recognition attempt in addition to or in place of the actual sound segment(s) in the request.

When the spoken request requires additional clarification or confirmation, the client agent 112 may prompt the user for more information or confirms the request using the speaker 340 or the visual indicators 344 in the client agent 112. The speaker 340 and the visual indicators 344 may also be used to let the user know that the agent 112 is processing a spoken request. In another embodiment, visual feedback is provided by changes to the images and/or audio presented by the consumer electronic device 104.

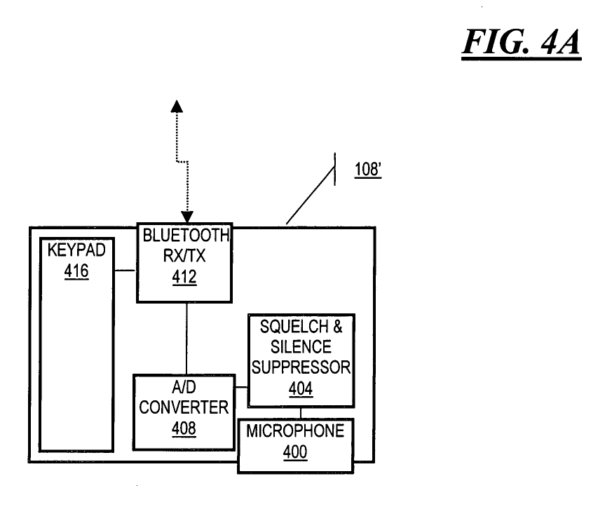

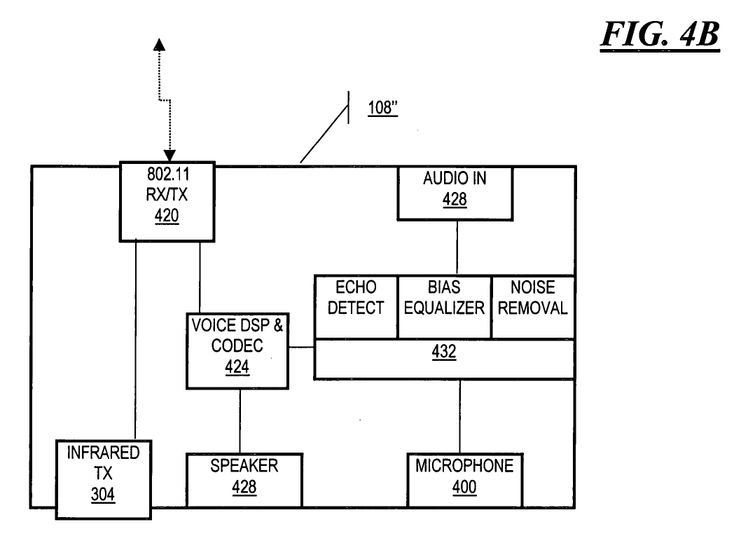

FIG. 3B presents another embodiment of the client agent 112′. The operation and structure of this embodiment is similar to the agent 112 discussed in connection with FIG. 3A, except that client agent 112′ lacks right microphone 312 and left microphone 312′. Instead, microphone functionality is provided in the voice-equipped universal remote 108′ of FIGS. 4A & 4B, which receives spoken requests, digitizes the requests, and transmits the digitized requests through a wireless connection to client agent 112′ through the agent's Bluetooth transceiver (RX/TX) 352. Such remote need not be a hand-held remote. Alternative embodiments may communicate with a client agent using analog audio connectors, e.g. XLR, digital audio connectors, e.g., USB, or communications connectors, e.g., HomePlug, to effect a transfer of audio signals from one or more microphone(s).

FIG. 3C presents still another embodiment of the client agent 112″. In this embodiment, the client agent 112″ lacks the sound and voice processing functionality of the embodiments of FIGS. 3A and 3B. Instead, this functionality is provided in the voice-equipped universal remote 108″ of FIG. 4B. As discussed in greater detail below, this remote 108″ receives spoken requests, performs sound and voice processing on the requests, and then transmits the results of the processing to the client agent 112″ using the remote's 802.11x transceiver 354.

More specifically and with reference to FIG. 4A, one embodiment of the remote 108′ includes a microphone 400 that provides an electrical waveform to the suppressor 404 corresponding to its measurement of ambient sound, including any spoken requests. The suppressor 404 filters the received waveform and provides it to the analog/digital converter 408, which digitizes the waveform and provides it to the Bluetooth transceiver (RX/TX) 412 for transmission to the client agent 112′. Other embodiments of remote control 108 suitable for use with the present invention use wireline communications, for example, communications using the X-10 or HomePlug protocol over power wiring in the CP. Embodiments may also include noise cancellation processing, similar to that in the voice DSP and codec 337. The remote 108′ may also include a conventional keypad 416.

This embodiment is useful when, for example, improved fidelity is desired. By locating the microphone 400 closer to the user, the signal-to-noise ratio of the measured signal is thereby improved. The wireless link between the remote control 108′ and the client agent 112′ may be implemented using infrared light but, due to the lack of line of sight for transmission, the greater distances likely between a viewing area in another room from a multi-port embodiment of the invention, and the bandwidth required for voice transmission, a higher capacity wireless link such as Bluetooth or 802.11x is desirable. Since voice and sound processing are not performed in this embodiment of the remote 108′, this embodiment is better suited for interoperation with a client agent 112, 112′ that includes such functionality.

In other embodiments tradeoffs are made between the amount of processing done at the remote control 108″ and the bandwidth required to support a connection between the remote control 108″ and the client agent 112″. For example, with reference to FIG. 4B, if the localized request processing described above is performed at the remote control unit 108″, instead of at the client agent 112″, only the identified keywords and any unrecognized segments would be transmitted to the client agent 112″ using an 802.11x transceiver 420, reducing the bandwidth required to maintain a connection between the remote control unit 108″ and the agent 112″. If the localized processing in the remote control 108″ is limited to noise cancellation and/or signal processing of recorded sounds plus application of control directives, as via 304, then the bandwidth requirement would be higher. Accordingly, the remote 108″ includes its own codec 424, speaker 428, and signal processing module 432, which operate as discussed above. Some embodiments also include infrared reception and transmission ports, 300 and 304 respectively, or equivalents.

Exemplary Upstream Hardware Installation

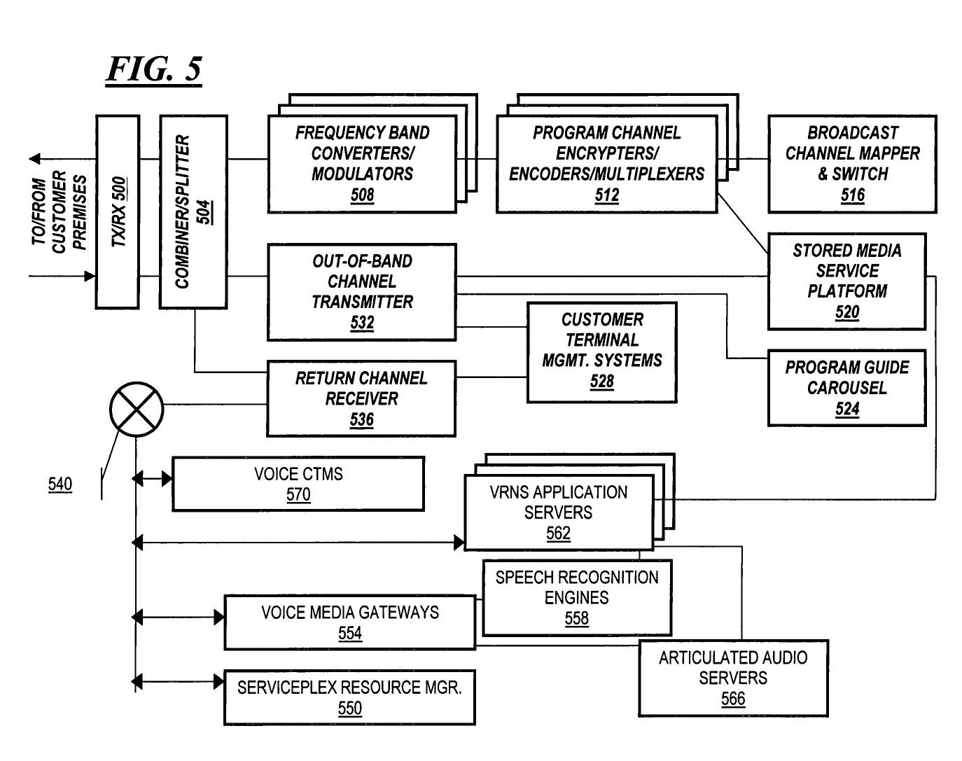

The CPE of the present invention may be accompanied by SOP equipment to process those spoken requests that either cannot be adequately identified by the CPE or cannot be adequately serviced by the CPE. The SOP equipment may also route directives and/or commands to equipment to effect the request, in whole or in part, and/or apply commands in or via equipment located off the CP. FIG. 5 presents an exemplary SOP installation, with the hardware typical of a cable television DSO indicated in bold italic typeface and numbered 500 through 540.

In a typical cable television DSO system, entertainment programming “feeds” or “streams” are delivered to the system operator by various means, principally including over-air broadcast, microwave, and satellite delivery systems. The feeds are generally passed through equipment designed to retransmit the programming without significant delay onto the residential cable delivery system. The Broadcast Channel Mapper & Switch 516 controls and assigns the channel number assignments used for the program channel feeds on the particular cable system. Individual cable channels are variously spliced, for example to accept locally inserted advertisements, alternative sound tracks and/or other content; augmented with ancillary or advanced services data; digitally encoded, for example using MPEG-2; and may be encrypted or remain “in the clear”.

Individual program streams are multiplexed into one or more multi-program transport streams (with modifications to individual program stream bit-rates, insertion of technical program identifiers, and alignment of time codes) by a Program Channel Encrypter, Encoder, & Multiplexer (PCEEM) 512, of which there are typically a multiplicity, the output of which is, in a digital cable system, a multi-program transport stream containing approximately 7 to 10 standard definition television channels. As most modern cable delivery systems offer many more than 10 channels of programming, multiple multi-program transport streams are further multiplexed by Frequency Band Converters & Modulators 508—sometimes called “up-band converters”—of which there are typically a multiplicity, which modulate individual transport streams to a frequency band allocated for those channels by the DSO. There being one physical cable to carry many frequency bands and many channels of programming and other services, a Combiner 504 aggregates multiple frequency bands and a Transmitter 500 provides those combined signals to the physical cable that extends from the DSO's headend premises to a subscriber's residence.

However, not all of the frequency domain capacity available in a modern cable plant is used in the retransmission of such apparently real-time programming. For analog cable television delivery systems, a Program Guide Carousel server 524 provides a repeating video loop with advertising and audio for inclusion by a PCEEM 512 as simply another program channel. For digital cable television delivery systems, the output of the carousel changes from video to data and the communication path changes to an out-of-band channel transmitter 532, which accomplishes the forward delivery of program schedule and other information displayed in the interactive program guide format often rendered by the set top box 100. The source information for the program guide carousel is delivered to the server 524 by a variety of information aggregators and service operators generally located elsewhere.

Stored Media Service Platforms (SMSPs) 520 capture content from the entertainment programming feeds sent over the delivery plant as described above. SMSPs 520 receive additional types and sources of programming variously by physical delivery of magnetic tape, optical media such as DVDs, and via terrestrial and satellite data communications networks. SMSPs 520 store these programs for later play-out to subscriber set top boxes 100 and/or television devices 104 over the delivery network, variously in a multi-access service such as pay-per-view or in an individual access service such as multimedia-on-demand (MOD). SMSPs 520 also deliver files containing program content to equipment such as digital video recorders (DVR) 104 on a customer's premises for later play-out by the DVR 104. SMSP 520 output is communicated to advertising inserters, channel groomers, and multiplexer equipment 512 as with apparently real-time programs or are similarly processed in different equipment then connected (not shown) to the converters 508. SMSPs 520 may initiate playout or delivery according to schedule or otherwise without requiring subscriber communications carried over a return or up-wire channel.

Accounting for use of such services is performed at the cable set top box 100, wherein the Out-Of-Band Control Channel is used by the SMSP 520 or an associated administrative system to poll each subscriber premises for reports on its consumption for billing purposes. Such reporting often arrives at the headend via an Out-Of-Band Control Channel Receiver (not shown). Where so configured, a communication path from the Return Channel Receiver 536 to the Stored Media Service Platform 520 (not shown) carries accounting for such shared-access services and requests for individual-access services such as VOD using accepted command protocols (e.g., DSM-CC, RTSP). For communications returning from the outside plant to the DSO premises, the receiver 500 and the splitter 504 reverse the process applied in the forward direction for the delivery of programming to subscribers, detecting signals found on the physical plant and disassembling them into constituent components. However, these components are usually found in different parts of the frequency domain carried by the cable plant.

For delivery systems offering broadband internet access services, a Customer Terminal Management System (CTMS) 528 is the counterpart to a cable modem (e.g., DOCSIS-compliant) located on the subscriber's premises. The CTMS 528 is substantially similar to a Digital Subscriber Loop Access Module (DSLAM) found in telephony delivery systems, in that both provide for the aggregation, speed matching, and packet-routed or cell-switched connectivity to a global communications network. In a different embodiment, delivery systems offering cable telephony services employ a logically similar (though technologically different) CMTS 528′ to provide connectivity for cable telephone subscriber equipment at the subscriber premises to a public switched telephone network (PSTN), virtual private network (VPN), inter-exchange carrier (IXC), or a competitive local exchange carrier (CLEC). Supporting all these and additional DSO equipment, but not shown in the illustration, are a variety of hardware and software-based information systems and controls used by service operators to affect the operations, administration, and maintenance of the equipment described, for example, providing inventory tracking, service provisioning, address and port administration, usage metering, security monitoring, and other operations and support systems essential to profitable operation of a DSO business.

The SOP equipment added to support the remote processing and service of spoken requests includes a router 540 in communication with the CPE through the return channel receiver 536 and through the out of band channel transmitter 532. The router 540 provides a network backbone supporting the interconnection of the serviceplex resource manager (SRM) 550, the voice media gateways (VMGs) 554, the VRNS application servers 562, and the voice CTMS 570. The articulated audio servers 566 and speech recognition engines 558 are in communication with the VMGs 554 and the VRNS application servers 562. Again, like the CPE, each of these individual components may represent one or a plurality of discrete packages of hardware, software, and networking equipment implementing that component or, in the alternate, may represent a package of hardware and software that is shared with another “individual” component. This flexibility lets DSOs select a site-specific implementation that best addresses the needs and requirements of users to be serviced by each SOP equipment installation.

The SRM 550 acts as a supervisory and administrative executive for the equipment added to the SOP. The SRM 550 provides for the control and management of the VMGs 554 and the other components of the VRNS SOP installation: the speech recognition engines 558, the VRNS application servers 562, the articulated audio servers 566, and the communication resources on which they rely. The SRM 550 directs each of these individual components to allocate or release resources and to perform functions to effect the spoken request recognition and application services described. An operator operates, supports, and manages the SRM 550 locally using an attached console or remotely from a network operations center.

By maintaining information concerning each VRNS platform's available and committed capacity, the SRM 550 provides load management services among the various VRNS platforms, allocating idle capacity to service new requests. The SRM 550 communicates with these individual components using network messages issued over either a physically-separate control network (not shown) or a pre-existing network installed at the system operator's premises using, for example, out-of-band signaling techniques.

In one embodiment, the SRM 550 aggregates event records used for maintenance, network address assignment, security, infrastructure management, auditing, and billing. In another embodiment, the SRM 550 provides proxy and redirection functionality. That is, the SRM 550 is instantiated on a computer that is separated from the VMGs 554. When CPE transmits a request for service to the SOP equipment, then the SRM 550 responds to the request for service with the network address of a specific VMG 554 that will be used to handle subsequent communications with the CPE until termination of the session or further redirection.

The VMGs 554 provide an interface between the cable system equipment and the VRNS equipment located on the system operator's premises. The addition of an interface layer lets each DSO select its own implementation of SOP equipment in accord with the present invention. For example, in one embodiment a DSO implements VRNS services in part using session-initiation protocol (SIP) for signaling, real-time transport protocol (RTP) for voice media transfer, and a G.711 codec for encoding sound for transfer. Other signaling, transport, and encoding technologies may be preferable depending on application.

With a signaled request for service acknowledged and sufficient resources allocated by the SRM 550, the VMGs 554 receive packets containing sound segments from the CPE and pass the packets to the speech recognition engines (SREs) 558 that have been allocated by the SRM 550. The SREs 558 apply signal processing algorithms to the sound segments contained in the received packets, parsing the segments and translating the segments into word forms. The word forms are further processed using a language interpreter having predicate logic and phrase/sentential grammars. As discussed above, in various embodiments there are a set of logic and grammars that are shared among the various applications, a set of logic and grammars that are specific to each application, or both.

The application servers 562 provide the services requested by users through their CPE. In one embodiment, a first type of application server 562, such as a speech-recognizing program guide, deduces particular actions from a set of potential actions concerning the cable broadcast channel services provided to consumers using information previously stored on-board the server 562. This category of potential actions is typically processed remotely and the resulting commands are transmitted to the CPE for execution.

In another embodiment, a second type of application server 562, such as a speech-recognizing multimedia-on-demand system or a speech-recognizing digital video recorder, requires information accessible from other cable system platforms to deduce actions that are most readily executed through direct interaction with a cable service platform located, for example, at a DSO's SOP.

In still another embodiment, a third type of application server 562, such as a speech-recognizing web browsing service, requires information or interaction from systems outside the DSO's network. This type of application server 562 extracts information from, issues commands to, or affects transactions in these outside systems. That is, while the first and second types of application servers 562 may be said to be internal services operated by and on behalf of the DSO, the third type of application server 562 incorporates a third party's applications. This is true regardless of whether the third party's application is hosted, duplicated, or cached locally to the SOP, the DSO's network, or whether the application is maintained entirely off the DSO's network. Of course, these identified application servers are merely exemplary, as any variety of application servers 562 are suited to use with the SOP equipment of the present invention.

In operation, when the SREs 558 have finished processing the segments and the application servers 562 have decided that an appropriate course of action involves multiple system responses, a list of individual commands and command sequences is prepared for execution to effect changes implied by the requested service.

For those sequences requiring channel change or other action in the CP set top box or the CP electronic device, the application servers 562 issue archetypal remote control instructions to the client agent through one of the forward channel communications paths available downwire on the cable system. When these archetypal commands are received in the client agent, the archetypal commands are translated into device-specific commands to execute the required action on the CPE. In turn, the client agent transmits via the infrared port 304 the translated commands for reception and ultimately execution by the set top box, the consumer electronic device, or both.

When fulfillment of a request requires additional information to be requested from or delivered to a user, then an articulated audio server 566 is triggered to fulfill the request or delivery. In various embodiments, the audio server 566 is implemented as a library of stored prerecorded messages, text-to-speech engines, or another technology for providing programmatic control over context-sensitive audio output. The output from the audio server 566 is transmitted to the CPE through a forward channel communications path. At the consumer's premises, this output is decoded and played for the user via the speaker 340. In other embodiments, the trigger invokes an audio server whose library is stored on the CP in a device other than the client agent or a client agent with sufficient storage capacity. In still other embodiments, the entire function of the audio server is located on the CP, and the maintenance of associated libraries, in some of these cases, is accomplished remotely via one or more of the network service connections described.

Methods for Processing Spoken Requests

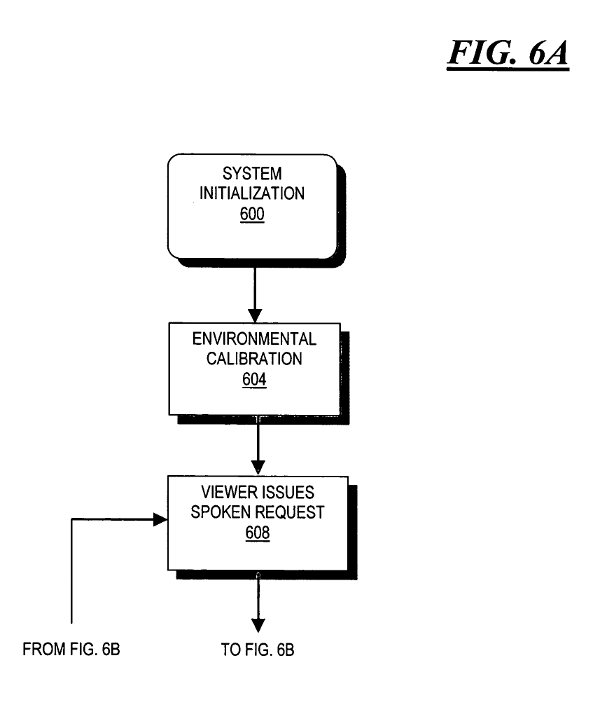

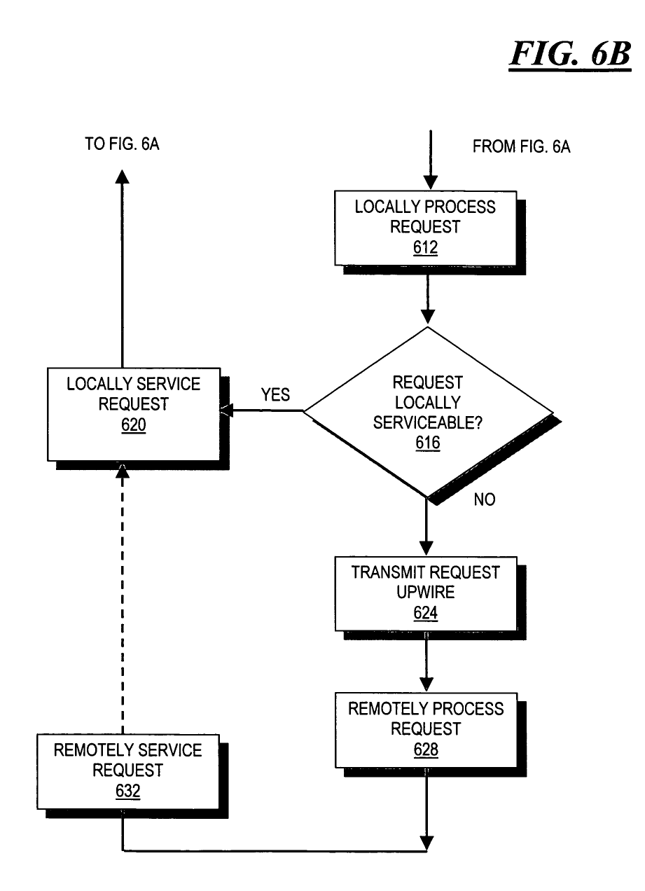

FIGS. 6A and 6B illustrate one embodiment of a method for the provision of network services using spoken requests in accord with the present invention. A viewer, using a remote control unit, activates a set top box or a consumer electronic device. A client agent receives the same command through, e.g., an infrared receiver port, and begins its own power-up/system initialization sequence (Step 600). In one embodiment, the client agent establishes communications with upwire hardware during system initialization. For example, the client agent may broadcast its presence to the upwire hardware and systems or it may instead await a broadcast message from the upwire hardware and systems instructing it as to its initialization data and/or procedures.

When the client agent establishes communications with the upwire hardware, the client agent may load its initial data and programming, e.g., an operating system microkernel, from the upwire hardware. If the client agent is not able to establish the upstream connection in a reasonable time or at all, the agent may consult its own memory for its initial programming, including software version numbers, addresses and port assignments, and keys or other shared secrets. Upon the subsequent establishment of communications with upstream hardware, the client agent compares the versions of its programming with the most current versions available from the upstream hardware, downloading any optional or necessary revisions.

After the client agent completes its initialization (Step 600), the agent calibrates itself to its operating environment (Step 604). The client agent measures the level of ambient sound using one or a plurality of microphones, adjusts the level and tone of the measured sound, and baselines the noise-cancellation processes—described above—as applied to eliminate noise from signals collected from consumer's premises.

After the unit has completed its initialization (Step 600) and environmental calibration (Step 604), it enters a wait state, until a viewer within range of the unit issues a spoken request. When a viewer issues a spoken request (Step 608), the request is detected by the unit as a sequence of sound segments distinguished from the background noise emanating from any consumer electronic devices.

The spoken request is first processed locally by the client agent (Step 612). A typical request is “Listen: watch ESPN,” or some other program name or entertainment brand name. The client agent distinguishes the request from the background noise, identifies the keyword request prompt, e.g., “Listen:,” and then parses the following words as a possible command request, seeking context-free matches in its dictionary. In one embodiment, sound preceding utterance of an initiating request prompt is ignored. In other embodiments, the CP agent 112 evaluates syntactic and/or semantic probabilities and deduces the relevance of each utterance as a possible request without strictly relying on a single initiating keyword.

If the request is locally serviceable (Step 616), then the client agent appropriately services commands locally (Step 620). Illustrative requests suited to local service include “power on,” “power off,” “lower volume,” “raise volume,” “mute audio,” “previous channel,” “scan channels,” “set channel scan pattern,” “set channel scan rate,” “stop scan,” and “resume scan.” Command execution involves mapping the words identified in the segments onto the commands or list of commands needed to achieve the requested action.

As this operational mode of being always on might be undesirable at times, the present invention recognizes a request to “Stop Listening”. The system's normative response is to enter a state in which no request, other than a specific request to resume listening, is honored. Similarly, a request to “Stop Sending” causes the system to adopt a normative response of terminating any communication from the client agent on the CP up-wire to any counterparty. These, similar requests, and more graduated mechanisms afford users control over what and when the invention processes inputs and over the degree of privacy of the CP protected by the present invention.

Alternately, when the client agent 112 has a connection (wired or wireless) to the set top box 100, the set top box 100 may control the operation of the agent 112 such that it selectively listens for requests or disables its listening. For example, the set top box 100 may turn on the agent 112 when the set top box 100 itself is turned on, and the set top box 100 may turn off the agent 112 when the set top box 100 itself is turned off. Or, in another embodiment, the set top box 100 enables the operation of the agent 112 when the user selects an EPG channel for viewing and, once the user has issued an appropriate request that changes the channel from the EPG channel, the set top box 100 disables the operation of the agent 112.

As discussed above, issuing commands to consumer electronic devices at the CP entails mapping from one or more requests to the particular command(s) needed for the actual device(s) installed at the user's location. Continuing with the example of a spoken request for “WBZ”, the commands could be issued as the infrared commands “0”, “4”, and “Enter” using coded command set “051” to correspond to, in this example, the Quasar television set Model TP3948WW present on the CP.

Command execution is further complicated by the multiplicity of devices likely being used at a CP, and by differences among the command codes these devices recognize and implement. For example, for a CP installation with a television set, a cable set top box, and a video cassette recorder (VCR), the set of commands issued in response to a spoken “Power On” request is, characteristic of some configurations of consumer electronic devices, to power up the television set, change the television set to channel 3, power up the cable set top box, and optionally select the Source Cable/TV to cable. In the case of configurations using Picture-In-Picture features of some television sets, the device providing the secondary tuner, a VCR in this example, would similarly be powered up, channel tuned and source selected.

If a request is not locally serviceable, either because it cannot be understood or because the actions required to service the request cannot be completely performed locally (e.g., a multimedia-on-demand purchase), then the service request signals and collected sound segments are sent upwire or over a LAN to a network-enabled computing device (Step 624). This device may include speech recognition and/or applications processing capabilities, or it may simply be, e.g., a networked computer acting as a media server or other speech-controlled peripheral device.

If the request is not completely processed locally, then the request processing is completed remotely (Step 628). Using the computing resources available at the system operator's premises, or elsewhere, keywords are identified from the speech segments that could not be resolved completely using the equipment at the customer's premises. To the extent that the resulting requests are susceptible to remote service, e.g., an order for a multimedia-on-demand program or an electronic commerce transaction, the requests are serviced remotely (Step 632).

If the request is not serviceable remotely, e.g., it is a locally-serviceable request that was not successfully identified by the CPE, then the SOP equipment transmits appropriate commands downstream to the customer premises' equipment for local servicing (Step 620). In one embodiment, the SOP hardware, cognizant of the configuration of the CPE through information received during the initialization of the CPE (Step 600), generates the appropriate sequence of commands and transmits them to the CPE for transmission to a consumer electronic device or set top box.

In another embodiment, the SOP equipment generates an archetypal command such as “increase volume” and transmits the command to the CPE for service (Step 620). In turn, the CPE translates the archetypal command into appropriate commands specific to the consumer electronic devices or set top boxes installed at the customer's premises and locally transmits them to the CPE. Successful processing of the request may be acknowledged to the user through a spoken or visual acknowledgment.

When the request has been successfully serviced, either remotely or locally, then the process repeats, with the CPE awaiting the issuance of another spoken request by the user (Step 608). The session or connection between the CPE and the SOP equipment may be dropped or, optionally, maintained. Where such session or connection remains, one embodiment allows the viewer to omit utterance of an initiating request prompt or keyword. When the user is done viewing programming or requesting network services, the user instructs the CPE to turn itself off, uses a remote control unit, or simply allows a count-down timer to expire to achieve the same effect.

Parameter Configuration

In some embodiments, program guide and other information used by components of the invention located on CP are installed in advance of physical installation of the instance of the embodiment on CP. In other embodiments, the information, instruction, and procedures essential to speech processing, linguistic interpretation processing, fulfillment processing, and/or other application processing are delivered, either in whole or in part, whether proscriptively, preemptively or on demand, whether all at once or over time, to a CP and one or more client agents 112, for example, as over one or more networks or as with one or more removable or portable media. Such information includes, but is not limited to, acoustic models, language models, dictionaries, grammars, and names. For example, in some embodiments, information used in a speech-activated interactive program guide application is received by the client agent 112 over a cable in a manner essentially similar to that used by a set top box through an out-of-band receiver 312 or OOB over DOCSIS capability 320. In other embodiments, the guide data is acquired by the client agent 112 through a DOCSIS cable modem capability 320 from a service accessible via an internet. Such data may, for example, describe television programming, movie theater programming, radio programming, media stored on a local (e.g., DVR) or remote media server or Stored Media Service Platforms 520. Various push methods, such as used by the server 524 or in multicast features off Internet Protocol, and pull methods, such as used in accessing an HTTP server using TCP, are suitable for communicating such data. Where data are communicated in encrypted or encoded forms, they would be decrypted at the customer premise, whether performed in the client agent 112 or prior to its receiving such data.

In some embodiments, the information used by components of the invention located on CP are selected to fit the particular speech, language, and application patterns in individual CPs or in aggregations of CPs, such as neighborhoods, municipalities, counties, states, provinces, or regions. For example, an installation in Bedford, Mass., serving a family of English and non-English speakers could be configured with acoustic and language model information distinct from that used to configure an installation in Houston, Tex., serving a family of English and non-English speakers. The different configurations may be tailored, for example, to account for language differences (e.g., between Spanish and Portuguese, and between either Spanish and Portuguese or English), differences between speech affect (e.g., Texas affect and Massachusetts affect), and to accommodate the differences in English dialects prevalent in Texas and Massachusetts. In some embodiments, such selections of information provide a starter set of data which is subsequently further adapted to the patterns observed, for example, based on experience in use and feedback.

In some embodiments, parameters controlling or informing operation of the components of the invention located on CP are configured by the end user and/or on behalf of the user by a service operator and stored and/or applied, at least in part, local to the CP. In some embodiments, such configuration is affected by voice command of the local device by the user, wherein said command is processed locally. In other embodiments, such configuration is affected either remotely via services provided by a network operator, for example via a call center, or locally by a third-party installer.

In some embodiments, with respect to embedded sub-systems such as the noise cancellation, sound and environment analyses, the selection of appropriate software, algorithms, parameters, acoustic or linguistic models, and their configuration are deduced at a remote location. In such embodiments, sound may be sampled for the remote location in real time via a pass-through or tunneling method, or a sound sample may be recorded, in some cases processed, and forwarded to a remote processing facility. In some embodiments, configuration choices may be deduced via conversation with a representative of a service provider. In yet other embodiments, a sound recording made on the CP is sent from one or more of the local components of the invention to a remote facility for analysis by either human, assisted human, or automated means. In all such cases, the resulting parametric information may be communicated to the CP for application by a person there, or communicated to the equipment on the CP as via a network.

Commercial Applications

As discussed above, embodiments of the present invention let a user direct the viewing of or listening to media content (e.g., broadcast, stored, or on demand) by channel number, channel name, program name, or more detailed metadata information that is descriptive of programs (e.g., the name of a director, actor, or performing artist) or a subset of programs (e.g., name of a genre classification) through the use of spoken requests. The user may also control the operation of their on-premises equipment through spoken requests.

This generalized, speaker-independent, voice-recognition technology is suited to other commercial applications. For example, in one embodiment of the present system, a user orders pay-per-view and/or multimedia-on-demand programming with spoken requests. In another embodiment, a user issues spoken requests to purchase merchandise (e.g., “I want that hat, but in red”) or order services (e.g., “I want a pizza”) that are optionally advertised on the customer's on-premises equipment. Such merchandise may include media products (e.g., “Buy the Season 7 Boxed Set of The West Wing”) deliverable physically or via network, for example, for local storage on a DVD or MP-3 Player. In still another embodiment, a user issues a spoken request to retrieve information, for example, of a personal productivity nature (e.g., “What is the phone number for John in Nina's class?”) or of commercial nature (e.g., “How late is the supermarket open tonight?”). In yet another embodiment, a user issues a spoken request concerning personal health, security, and/or public safety (e.g., “EMERGENCY!”).

With the addition of an appropriate interface, e.g., SS-7 or SIP, the CP equipment may also operate and control telephone-related hardware. For example, the CPE could display caller ID information concerning an incoming telephone call on a television screen and, in response to a spoken request to “Take a message,” “Send it to voicemail,” or “Pick it up,” store messages in CPE memory or allow the user to answer the telephone call using the speaker and microphone built into the CPE.

In those embodiments where the CPE utilizes speaker-dependent or speaker-specific libraries to identify and/or classify the person speaking the received segments, the identity and/or classification of the speaker may be used to facilitate these commercial applications by, for example, retrieving or validating stored credit card or shipping address information. Other information descriptive of or otherwise associated with the speaker's identity, e.g., gender or age, may be used to facilitate market survey, polling, or voting applications. In other embodiments, biometric techniques are used to identify and/or classify the speaker.

The embodiments of the present invention also provide owners of entertainment trademarks with several mechanisms to more effectively realize value from the goodwill established for their brands using other media channels, advertising, and customer experiences. Requests for particular brand names are processed by the present invention in ways consistent with brand meaning. As discussed above, requests for an entertainment brand associated with a broadcast station may be fulfilled as a Channel Change of the tuner using the best available source delivery network. Requests for entertainment program titles may be fulfilled as either a Channel Change, in the case of a current broadcast title, as either a Future Channel Change or a Future Record Video in the case of later scheduled broadcast titles, as a Playout Stored Demand Media in the case of the referent being a title available on a network based multimedia on demand service, as a Download & Store Media in the case of the referent being a title available for download or otherwise available for storage on the customer premise, for example but not limited, by printing the title on a recordable digital video disc (DVD-R), or as a Cinema Information directive in the case of the referent being a movie title scheduled for showing at a local movie theater. Such fulfillment can be performed in the foreground, thus readily apparent to the requester, or performed as a background task. Requests for entertainment brand-related or performer-related news may be fulfilled as database or Internet web site access directives. Similarly robust responses result from request names referring to musical groups, performances, songs, etc. Similarly robust responses also result from requests for sports teams or team nicknames, contests, schedules, statistics, etc. Using the present invention, parent organizations, such as Viacom, can package dissimilar products and brands together under one or more request names and respond with packages of entertainment titles loaded into a shortlist facility for viewing as a group. These tie-ins, advertisements, and other examples of marketing are facilitated by the present invention.

The embodiments of the present invention also provide owners of non-entertainment trade names with several mechanisms to realize similar benefits. The present invention provides trade name owners with mechanisms to invoke in response to a request for their brand by name. Normative responses include, but are not limited to, information, for example as to location, store hours, customer service contacts, products for sale, inventory and pending order status, directory listings, or information storable in a personal information manager or a similarly functional product applicable to groups or communities. Notably, the present invention does not constrain the possible normative responses to the entertainment domain.

Embodiments of the present invention provide delivery system operators with advertising opportunities. In one example, augmenting information that may be independent of the programmed content, however related to advertisements insertable for display during program breaks, is supplied. In this example, a DSO can use the present invention to offer a service to advertisers wherein a short-form advertisement is supported by additional information available for the asking. Today, a viewer of the PBS program “Frontline” is encouraged in a program trailer that “to learn more about (the topic just covered in the program aired), visit us on the web at www.pbs.org”. With the present invention, the normative response to a request from a user to “Learn More” or “Go There” is to remember the then current channel setting, change the channel to one reserved for internet browser output, summon and display the HTML page provided at a URL provided in the augmenting information, and await further direction from the user. In other embodiments, the augmenting information causes the “Go There” request to call on a long-form video clip which may be stored on a network resident VOD server, a CP-located digital/personal video recorder/player, or a computer configured in the role of a media server. In still other embodiments, the request that will trigger the fulfillment of an augmented-information follow-on is a variable determined by the advertiser and communicated to the present invention as augmenting information. In still other embodiments, a “Learn More” request would initiate a sequence of actions whereby information normally part of an advertising insertion system is referenced to determine the identity of the advertiser associated with the advertisement being shown contemporaneous with the request. In other embodiments, a normative response is to initiate the construction and/or delivery of a personalized or otherwise targeted advertisement that may in turn incorporate or rely on information specific to the viewer and/or the buying unit represented by the household located at that customer premise.

Embodiments of the present invention are not limited to applications calling for the delivery of media to the customer premise. Requests may result in the making of a title, such as a digital album of photographs stored on the customer premise, available either for remote viewing by a third party, as in use of a personal web server, or for transfer of the title to a storage, servicing, or other facility located elsewhere.

Embodiments of the present invention provide for the monitoring, measurement, reporting, and analyses of consumer presence, identity, classification, context, utterance, request, and selection data with varying degrees of granularity and specificity. Some embodiments focus entirely on requests and commands disposed through the present invention, while other embodiments sense, monitor, or otherwise track use of consumer electronic devices present on the customer premises or the communication network(s) used by them for additional data. Some embodiments rely entirely on observation and data collection at each customer premise client agent. Other embodiments aggregate observations for multiple client agents at a consolidation point at the customer premise before communicating the information to a remote collection point. Still other embodiments include aspects or components of measurement, aggregation, and analyses integral to or co-located with DSO equipment and applications, as in the case of recording use of t-commerce applications.

In some embodiments, an accumulation of individual measurements and/or an analysis of such observations is an input to a weighting and scoring aspect of the present invention facilitating the decoding, matching, and/or interpretation of a request. In some embodiments, a history of such scorings and weightings is associated with consequential directives or commands, so, for example, to facilitate resolution of ambiguous requests. In some embodiments, such scorings and weightings are used to deprioritize selections considered “single use” in favor of prioritizing selections not previously made. In other embodiments intent on facilitating ease of subsequent uses, such scorings and weightings are used to increase previously requested selections.

Many alterations and modifications may be made by those having ordinary skill in the art without departing from the spirit and scope of the invention. For example, although embodiments of the present invention have been discussed as communicating with cable head-end equipment in connection with their processing and service efforts, other embodiments of the present invention communicate with remotely-placed equipment using, for example, dial-up, leased line, digital subscriber loop, wireless, and/or satellite communications, and may receive parametric, metadata or other information from remotely-sited equipment through the use of a color, wavelength, frequency, subcarrier, subchannel, VBI, a switched or routed protocol, such as accomplished by multicast and IGMP features of the internet protocols (IP), asynchronous transfer mode (ATM), synchronous optical network (SONET), or other transmissions signals.

Therefore, it must be expressly understood that the illustrated embodiments have been shown only for the purposes of example and should not be taken as limiting the invention, which is defined by the following claims. The following claims are thus to be read as not only literally including what is set forth by the claims but also to include all equivalents that are insubstantially different, even though not identical in other respects to what is shown and described in the above illustrations.

1. An apparatus that permits a user to obtain services using spoken requests, the apparatus comprising:
at least one microphone to capture at least one sound segment;
at least one processor configured to identify a first serviceable spoken request from the captured segment;
at least one transceiver for communications related to at least one of the apparatus, executable code thereon, service availability, administration, media, a media description, or the captured segment,
wherein the processor is configured to identify the serviceable spoken request.

2. The apparatus of claim 1 further comprising:
an interface to provide a communication related to the captured sound segment to a second processor;
configuring said second processor to identify a second serviceable spoken request from the communication; and
operating a second apparatus in response to a command received in response to the first or second serviceable spoken request or both,
wherein the processor transmits the communication to the second processor for further identification.

3. The apparatus of claim 1 further comprising an interface configured to receive information derived from an audio source to be used for noise cancellation.

4. The apparatus of claim 2 wherein the transmitted communication comprises at least one phoneme in an intermediate form.

5. The apparatus of claim 2 wherein the first and second serviceable spoken requests are the same.

6. The apparatus of claim 2 wherein the first and second serviceable spoken requests are different.

7. A method for processing a spoken request, the method comprising:
identifying a serviceable spoken request from a sound segment;
transmitting a communication related to the sound segment for further servicing; and
operating an apparatus in response to a command received in response to the communication.

8. The method of claim 7 wherein the transmitted communication comprises at least one phoneme.

9. The method of claim 7 further comprising using stored information to determine the identity of the speaker of the sound segment.

10. The method of claim 9 further comprising employing stored information concerning the speaker's identity or preferences using the determined identity.

11. The method of claim 7 further comprising using stored information to determine a characteristic associated with the speaker of the sound segment.

12. The method of claim 7 further comprising:
applying noise cancellation techniques to the sound segment.

13. The method of claim 7 further comprising:
receiving information concerning an audio signal;
determining a relationship between the information and the sound segment; and
utilizing the relationship to improve the processing of a second sound segment.

14. A method for content selection using spoken requests, the method comprising:
receiving a spoken request;
processing the spoken request;
transmitting the spoken request in at least one of an intermediate form, a directive, or a command to equipment for servicing.

15. The method of claim 14 further comprising:
receiving a directive from the equipment to select a program, title, name or a content channel specified in the spoken request.

16. The method of claim 14 further comprising:
receiving a video signal, data stream, or file containing a program or content channel specified in the spoken request.

17. The method of claim 14 further comprising:
executing a command for affecting the operation of a consumer electronic device in response to the spoken request.

18. The method of claim 14 further comprising:
executing a command for affecting the operation of a home automation system in response to the spoken request.

19. The method of claim 14 further comprising:
playing an audio signal in response to the spoken request.

20. The method of claim 14 further comprising:
processing a commercial transaction in response to the spoken request.

21. The method of claim 14 further comprising:
executing a command proximate to the location of the speaker issuing the spoken request.

22. The method of claim 14 further comprising:
interacting, by the equipment, with additional equipment to further process the transmitted request.

23. The method of claim 22 wherein the interaction with additional equipment is determined by the semantics of the transmitted request.

24. The method of claim 14 wherein the equipment is within the same premises as the speaker issuing the spoken request.

25. The method of claim 14 wherein the equipment is not within the same premises as the speaker issuing the spoken request.

26. The method of claim 14 further comprising:
executing at least one command affecting the operation of at least one device or executable code embodied therein in response to the spoken request.

27. The method of claim 26 wherein the plurality of devices are geographically dispersed.

28. The method of claim 26 wherein the plurality of devices are selected from the group consisting of set top boxes, consumer electronic devices, network services platforms, servers accessible via a computer network, media servers, and network termination, edge or access devices.

29. The method of claim 26 wherein the plurality of devices are distinguished using contextual information from the spoken requests.

30. The method of claim 14 further comprising:
determining a plurality of possible responses corresponding to the spoken request; and
receiving the selection of at least one response from the plurality.

31. The method of claim 30 wherein the spoken request is a request for at least one television program.

32. The method of claim 31 wherein the plurality of possible responses comprise issuing a channel change command to select a requested program, issuing at least one command to schedule the recording of a requested program, issuing at least one command to order an on-demand version of a requested program, issuing at least one command to affect a download version of a requested program, or any combination thereof.

33. The method of claim 30 wherein the spoken request comprises a brand, trade name, service mark, or name referring to a tangible item or an intangible item.

34. The method of claim 33 wherein the plurality of responses comprise at least one channel change command for the selection of at least one media property associated with the spoken request.

35. The method of claim 30 wherein the plurality of responses is visually presented to the user and the user subsequently selects one response from the presented plurality.

36. The method of claim 30 wherein the plurality of responses is audially presented to the user and the user subsequently selects one response from the presented plurality.

37. The method of claim 30 wherein the selection of the response is made using contextual information.

38. The method of claim 14 further comprising:
issuing at least one command in response to the spoken request; and
operating an apparatus in response to the command.

39. The method of claim 38 wherein the issued command switches a selected media item to a higher-fidelity version of the media item.

40. The method of claim 38 wherein the issued command switches a selected higher-fidelity media item to a lower-fidelity version of the media item.

41. A method for equipment configuration, the method comprising:
transmitting a sound segment in an intermediate form;
processing the transmitted sound segment to identify at least one characteristic; and
utilizing the at least one characteristic for the processing of subsequent sound segments,
wherein the characteristic is associated with the speaker, room acoustics, consumer premises device acoustics, ambient noise, or any combination thereof.

42. The method of claim 41 wherein the at least one characteristic is selected from the group consisting of: geographic location, age, gender, biographical information, speaker affect, accent, dialect and language.

43. The method of claim 41 wherein the at least one characteristic is selected from the group consisting of: presence of animals, periodic recurrent noise source, random noise source, referencable signal source, reverberance, frequency shift, frequency-dependent attenuation, frequency-dependent amplitude, time, frequency, frequency-dependent phase, frequency-independent attenuation, frequency-independent amplitude, and frequency-independent phase.

44. The method of claim 41 wherein the processing is fully automated.

45. The method of claim 41 wherein the processing is human-assisted.

46. A method for speech recognition, the method comprising:
recording a sound segment;
selecting configuration data for processing recorded sound segments; and
using the selected data to process the recorded segments.

47. The method of claim 46 wherein the selection of the configuration data utilizes a characteristic identified from the recorded sound segment.

48. The method of claim 46 wherein the selected data is stored in a memory for use in further processing.

49. The method of claim 46 wherein the configuration data are received from a source.

50. The method of claim 46 wherein the configuration data are periodically received from a source.

51. The method of claim 46 wherein the configuration data is derived from selections made from a menu of options.

52. The method of claim 46 wherein the configuration data is derived from a plurality of recorded sound segments.

53. The method of claim 46 wherein the configuration data change as a function of time, time of day, or date.

54. The method of claim 14 further comprising:
discontinuing the processing of spoken requests in response to a spoken request, a directive, a command, or an event.

55. The apparatus of claim 1
wherein the processor is configured to identify the serviceable spoken request using speaker-tailored information.

56. The apparatus of claim 55 wherein the speaker-tailored information varies by gender, age, or household.

57. An electronic medium having executable code embodied therein for content selection using spoken requests, the code in the medium comprising:
executable code for receiving a spoken request;
executable code for processing the spoken request;
executable code for communicating the spoken request in an intermediate form; and
executable code for operating an apparatus in response to a command resulting at least in part from the spoken request.

58. The medium of claim 57 further comprising:
executable code for receiving a command for affecting selection of a program or content channel specified in the spoken request.

59. The medium of claim 57 further comprising:
executable code for executing a command for affecting the operation of a consumer electronic device in response to the spoken request.

60. The medium of claim 57 further comprising:
executable code for executing a command proximate to the location of the speaker issuing the spoken request.

61. The medium of claim 57 further comprising:
executable code for executing a plurality of commands affecting the operation of a plurality of devices in response to the spoken request.

62. The apparatus of claim 1 further comprising:
an interface for communications related to the configuration of the apparatus or electronic code thereon,
wherein the processor identifies serviceable spoken requests from the captured segment using configuration information received via the transceiver.

63. The apparatus of claim 62 wherein the configuration data is received from remote equipment.

64. The apparatus of claim 63 wherein the configuration data is received indirectly through another apparatus located on the same customer premises as the apparatus.

65. The method of claim 14 wherein configuration data received from remote equipment is used in the processing of the spoken request.

66. The method of claim 65 wherein the configuration data are received from equipment located off the premises.

67. The method of claim 14 further comprising:
accumulating data representative of at least one spoken request; and
analyzing the accumulated data.
